(19) United States
(12) Patent Application Publication
(10) Pub. No.: US 2012/0109993 A1
(43) Pub. Date: May 3, 2012

(54) Performing Visual Search in a Network

(75) Inventor: Yuriy Reznik, Seattle, WA (US)

(73) Assignee: QUALCOMM Incorporated, San Diego, CA (US)

(21) Appl. No.: 13/158,013

(22) Filed: Jun. 10, 2011

Related U.S. Application Data
(60) Provisional application No. 61/407,727, filed on Oct. 28, 2010.

(51) Int. Cl. G06F 17/30

(52) U.S. Cl. 707/765; 707/E17.019; 707/E17.027

(57) ABSTRACT

In general, techniques are described for performing a visual search in a network. A client device comprising an interface, a feature extraction unit and a feature compression unit may implement various aspects of the techniques. The feature extraction unit extracts feature descriptors from an image. The feature compression unit quantizes the image feature descriptors at a first quantization level. The interface that transmits the first query data to the visual search device via the network. The feature compression unit determines second query data that augments the first query data such that when the first query data is updated with the second query data the updated first query data is representative of the image feature descriptors quantized at a second quantization level. The interface transmits the second query data to the visual search device via the network to successively refine the first query data.

This application claims the benefit of U.S. Provisional Application No. 61/407,727, filed Oct. 28, 2010, which is hereby incorporated by reference in its entirety.

### TECHNICAL FIELD

This disclosure relates to image processing systems and, more particularly, performing visual searches with image processing systems.

### BACKGROUND

Visual search in the context of computing devices or computers refers to techniques that enable a computer or other device to perform a search for objects and/or features among other objects and/or features within one or more images. Recent interest in visual search has resulted in algorithms that enable computers to identify partially occluded objects and/or features in a wide variety of changing image conditions, including changes in image scale, noise, illumination, and local geometric distortion. During this same time, mobile devices have emerged that feature cameras, but which may have limited user interfaces for entering text or otherwise interfacing with the mobile device. Developers of mobile devices and mobile device applications have sought to utilize the camera of the mobile device to enhance user interactions with the mobile device.

To illustrate one enhancement, a user of a mobile device may employ a camera of the mobile device to capture an image of any given product while shopping at a store. The mobile device may then initiate a visual search algorithm within a set of archived feature descriptors for various images to identify the product based on matching imagery. After identifying the product, the mobile device may then initiate a search of the Internet and present a webpage containing information about the identified product, including a lowest cost for which the product is available from nearby merchants and/or online merchants.

While there are a number of applications that a mobile device equipped with a camera and access to visual search may employ, visual search algorithms often involve significant processing resources that generally consume significant amounts of power. Performing visual search with power-conscious devices that rely on batteries for power, such as the above noted mobile, portable and handheld devices, may be limited, especially during times when their batteries are near the end of their charges. As a result, architectures have been developed to avoid having these power-conscious devices implement visual search in its entirety. Instead, a visual search device is provided, separate from the power-conscious device, that performs visual search. The power-conscious devices initiate a session with the visual search device and, in some instances, provide the image to the visual search device in a search request. The visual search device performs the visual search and returns a search response specifying objects and/or features identified by the visual search. In this way, power-conscious devices have access to visual search but avoid having to perform the processor-intensive visual search that consumes significant amounts of power.

### SUMMARY

In general, this disclosure describes techniques for performing visual search in a network environment that includes a mobile, portable or other power-conscious device that may be referred to as a “client device” and a visual search server. Rather than send an image in its entirety to the visual search server, the client device locally performs feature extraction to extract features from an image stored on the client device in the form of so-called “feature descriptors.” In a number of instances, these feature descriptors comprise histograms. In accordance with the techniques described in this disclosure, the client device may quantize these histogram feature descriptors in a successively refinable manner. In this way, the client device may initiate a visual search based on a feature descriptor quantized at a first, coarse quantization level, while refining the quantization of the feature descriptor should the visual search require additional information regarding this feature descriptor. As a result, some amount of parallel processing may occur as the client device and the server may both work concurrently to perform the visual search.

In one example, a method for performing a visual search in a network system in which a client device transmits query data via a network to a visual search device is described. The method comprises storing, with the client device, data defining a query image, and extracting, with the client device, a set of image feature descriptors from the query image, wherein the image feature descriptors defines a at least one features of the query image. The method also comprises quantizing, with the client device, the set of image feature descriptors at a first quantization level to generate first query data representative of the set of image feature descriptors quantized at the first quantization level, transmitting, with the client device, the first query data to the visual search device via the network, determining second query data that augments the first query data such that, when the first query data is updated with the second query data, the updated first query data is representative of the set of image feature descriptor quantized at a second quantization level, wherein the second quantization level achieves a finer or more accurate representation of the set of image feature descriptors than that achieved when quantizing at the first quantization level, and transmitting, with the client device, the second query data to the visual search device via the network to refine the first query data.

In another example, a method for performing a visual search in a network system in which a client device transmits query data via a network to a visual search device is described. The method comprises receiving, with the visual search device, first query data from the client device via the network, wherein the first query data is representative of an a set of image feature descriptors extracted from an image and compressed through quantization at a first quantization level, performing, with the visual search device, the visual search using the first query data and receiving second query data from the client device via the network, wherein the second query data augments the first data such that when the first query data is updated with the second query data the updated first query data is representative of the set of image feature descriptors quantized at a second quantization level, wherein the second quantization level achieves a finer more accurate representation of the image feature descriptors than that achieved when quantizing at the first quantization level. The method also comprises updating, with the visual search device, the first query data with the second query data to generate updated first query data that is representative of the image feature descriptors quantized at the second quantization level and performing, with the visual search device, the visual search using the updated first query data.

In another example, a client device that transmits query data via a network to a visual search device so as to perform a visual search is described. The client device comprises a memory that stores data defining an image, a feature extraction unit that extracts an a set of image feature descriptors from the image, wherein the image feature descriptors defines at least one feature of the image, a feature compression unit that quantizes the image feature descriptors at a first quantization level to generate first query data representative of the image feature descriptors quantized at the first quantization level and an interface that transmits the first query data to the visual search device via the network. The feature compression unit determines second query data that augments the first query data such that when the first query data is updated with the second query data the updated first query data is representative of the image feature descriptors quantized at a second quantization level, wherein the second quantization level achieves a finer more accurate representation of the image feature descriptors than that achieved when quantizing at the first quantization level. The interface transmits the second query data to the visual search device via the network to successively refine the first query data.

In another example, a visual search device for performing a visual search in a network system in which a client device transmits query data via a network to the visual search device is described. The visual search device comprises an interface that receives first query data from the client device via the network, wherein the first query data is representative of a set of image feature descriptors extracted from an image and compressed through quantization at a first quantization level and a feature matching unit that performs the visual search using the first query data. The interface further receives second query data from the client device via the network, wherein the second query data augments the first data such that when the first query data is updated with the second query data the updated first query data is representative of the image feature descriptors quantized at a second quantization level, wherein the second quantization level achieves a finer more accurate representation of the image feature descriptors than that achieved when quantizing at the first quantization level. The visual search device also comprises feature reconstruction unit that updates the first query data with the second query data to generate updated first query data that is representative of the image feature descriptors quantized at a second quantization level. The feature matching unit performs the visual search using the updated first query data.

In another example, a device that that transmits query data via a network to a visual search device is described. The device comprises means for storing data defining a query image, means for extracting a set of image feature descriptors from the query image, wherein the image feature descriptors define at least one feature of the query image, and means for quantizing the set of image feature descriptors at a first quantization level to generate first query data representative of the set of image feature descriptors quantized at the first quantization level. The device also comprises means for transmitting the first query data to the visual search device via the network, means for determining second query data that augments the first query data such that, when the first query data is updated with the second query data, the updated first query data is representative of the set of image feature descriptor quantized at a second quantization level, wherein the second quantization level achieves a more accurate representation of the set of image feature descriptors than that achieved when quantizing at the first quantization level and means for transmitting the second query data to the visual search device via the network to refine the first query data.

In another example, a device for performing a visual search in a network system in which a client device transmits query data via a network to a visual search device is described. The device comprises means for receiving first query data from the client device via the network, wherein the first query data is representative of a set of image feature descriptors extracted from an image and compressed through quantization at a first quantization level, means for performing the visual search using the first query data, and means for receiving second query data from the client device via the network, wherein the second query data augments the first data such that when the first query data is updated with the second query data the updated first query data is representative of the set of image feature descriptors quantized at a second quantization level, wherein the second quantization level achieves a more accurate representation of the image feature descriptors than that achieved when quantizing at the first quantization level. The device also comprises means for updating the first query data with the second query data to generate updated first query data that is representative of the image feature descriptors quantized at the second quantization level and means for performing the visual search using the updated first query data.

In another example, a non-transitory computer-readable medium comprising instruction that, when executed, cause one or more processors to store data defining a query image, extract an image feature descriptor from the query image, wherein the image feature descriptor defines a feature of the query image, quantize the image feature descriptor at a first quantization level to generate first query data representative of the image feature descriptor quantized at the first quantization level, transmit the first query data to the visual search device via the network, determine second query data that augments the first query data such that when the first query data is updated with the second query data the updated first query data is representative of the image feature descriptor quantized at a second quantization level, wherein the second quantization level achieves a more accurate representation of the image feature descriptor data than that achieved when quantizing at the first quantization level and transmit the second query data to the visual search device via the network to successively refine the first query data.

In another example, a non-transitory computer-readable medium comprising instruction that, when executed, cause one or more processors to receive first query data from the client device via the network, wherein the first query data is representative of an image feature descriptor extracted from an image and compressed through quantization at a first quantization level, perform the visual search using the first query data, receive second query data from the client device via the network, wherein the second query data augments the first data such that when the first query data is updated with the second query data the updated first query data is representative of the image feature descriptor quantized at a second quantization level, wherein the second quantization level achieves a more accurate representation of the image feature descriptor than that achieved when quantizing at the first quantization level, update the first query data with the second query data to generate updated first query data that is representative of the image feature descriptor quantized at a second quantization level and perform the visual search using the updated first query data.

In another example, a network system for performing a visual search is described. The network system comprises a client device, a visual search device and a network to which the client device and visual search device interface to communicate with one another to perform the visual search. The client device includes a non-transitory computer-readable medium that stores data defining an image, a client processor that extracts an image feature descriptor from the image, wherein the image feature descriptor defines a feature of the image and quantizes the image feature descriptor at a first quantization level to generate first query data representative of the image feature descriptor quantized at the first quantization level and a first network interface that transmits the first query data to the visual search device via the network. The visual search device includes a second network interface that receives the first query data from the client device via the network and a server processor that performs the visual search using the first query data. The client processor determines second query data that augments the first query data such that when the first query data is updated with the second query data the updated first query data is representative of the image feature descriptor quantized at a second quantization level, wherein the second quantization level achieves a more accurate representation of the image feature descriptor than that achieved when quantizing at the first quantization level. The first network interface transmits the second query data to the visual search device via the network to successively refine the first query data. The second network interface receives the second query data from the client device via the network. The server updates the first query data with the second query data to generate updated first query data that is representative of the image feature descriptor quantized at a second quantization level and performs the visual search using the updated first query data.

The details of one or more examples are set forth in the accompanying drawings and the description below. Other features, objects, and advantages will be apparent from the description and drawings, and from the claims.

### BRIEF DESCRIPTION OF DRAWINGS

FIG. 1 is a block diagram illustrating an image processing system that implements the successively refinable feature descriptor quantization techniques described in this disclosure.

FIG. 2 is a block diagram illustrating a feature compression unit of FIG. 1 in more detail.

FIG. 3 is a block diagram illustrating a feature reconstruction unit of FIG. 1 in more detail.

FIG. 4 is a flowchart illustrating exemplary operation of a visual search client device in implementing the successively refinable feature descriptor quantization techniques described in this disclosure.

FIG. 5 is a flowchart illustrating exemplary operation of a visual search server in implementing the successively refinable feature descriptor quantization techniques described in this disclosure.

FIG. 6 is a diagram illustrating a process by which a feature extraction unit determines a difference of Gaussian (DoG) pyramid for use in performing keypoint extraction.

FIG. 7 is a diagram illustrating detection of a keypoint after determining a difference of Gaussian (DoG) pyramid.

FIG. 8 is a diagram illustrating the process by which a feature extraction unit determines a gradient distribution and an orientation histogram.

FIGS. 9A, 9B are graphs depicting feature descriptors and reconstruction points determined in accordance with the techniques described in this disclosure.

FIG. 10 is a time diagram illustrating latency with respect to a system that implements the techniques described in this disclosure.

### DETAILED DESCRIPTION

In general, this disclosure describes techniques for performing visual search in a network environment that includes a mobile, portable or other power-conscious device that may be referred to as a “client device” and a visual search server. Rather than send an image in its entirety to the visual search server, the client device locally performs feature extraction to extract features from an image stored on the client device in the form of so-called “feature descriptors.” In a number of instances, these feature descriptors comprise histograms. In accordance with the techniques described in this disclosure, the client device may quantize these feature descriptors (which, again are often in the form of a histogram) in a successively refinable manner. In this way, the client device may initiate a visual search based on feature descriptors quantized at a first, coarse quantization level, while refining the quantization of the feature descriptors should the visual search require additional information regarding this feature descriptors. As a result, some amount of parallel processing may occur as the client device and the server may both work concurrently to perform the visual search.

For example, the client device may first quantize the feature descriptors at the first, coarse quantization level. This coarsely quantized feature descriptors are then sent to the visual search server as first query data, which may proceed to perform a visual search based on this first query data. While performing this visual search with the coarsely quantized feature descriptor, the client device may determine additional or second query data that augments the first query data such that, when the first query data is updated with the second query data, the updated first query data is representative of the histogram feature descriptors quantized at a second quantization level.

In this manner, the techniques may reduce latency associated with performing a visual search in that query data is iteratively determined and provided by the client device to the visual search server concurrently with the visual search server performing the visual search. Thus, rather than transmit the entire image, which may consume significant amounts of bandwidth, and then wait for the visual search server to complete the visual search, the techniques may send feature descriptors and thereby conserve bandwidth. Moreover, the techniques may avoid sending the image feature descriptors in their entirety, and provide a way to successively refine the image feature descriptors in a manner that reduces latency. The techniques may achieve this latency reduction through careful structuring of the bitstream or query data in a manner that facilitates updates to the previously sent query data such that the updated query data provides the image feature descriptors quantized at a finer, more complete or more accurate level of quantization.

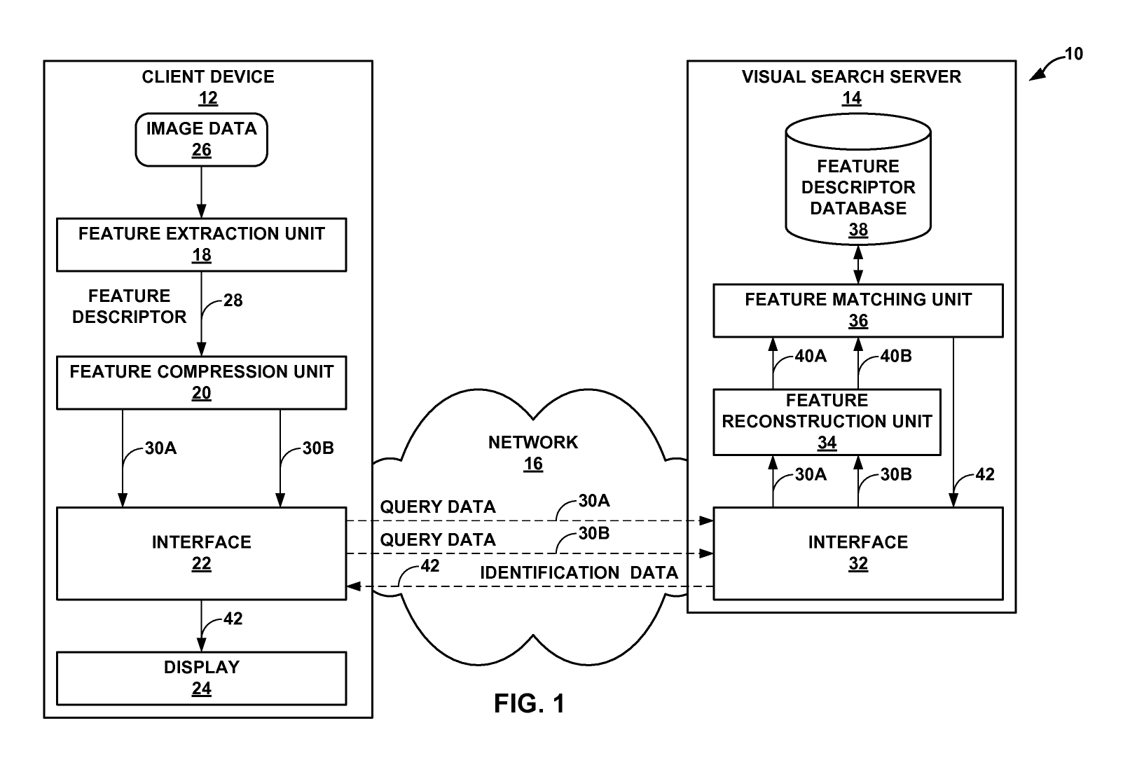

FIG. 1 is a block diagram illustrating an image processing system 10 that implements the successively refinable quantization techniques described in this disclosure. In the example of FIG. 1, image processing system 10 includes a client device 12, a visual search server 14 and a network 16. Client device 12 represents in this example a mobile device, such as a laptop, a so-called netbook, a personal digital assistant (PDA), a cellular or mobile phone or handset (including so-called “smartphones”), a global positioning system (GPS) device, a digital camera, a digital media player, a game device, or any other mobile device capable of communicating with visual search server 14. While described in this disclosure with respect to a mobile client device 12, the techniques of described in this disclosure should not be limited in this respect to mobile client devices. Instead, the techniques may be implemented by any device capable of communicating with visual search server 14 via network 16 or any other communication medium.

Visual search server 14 represents a server device that accepts connections typically in the form of transmission control protocol (TCP) connections and responds with its own TCP connection to form a TCP session by which to receive query data and provide identification data. Visual search server 14 may represent a visual search server device in that visual search server 14 performs or otherwise implements a visual search algorithm to identify one or more features or objects within an image. In some instances, visual search server 14 may be located in a base station of a cellular access network that interconnects mobile client devices to a packet-switched or data network.

Network 16 represents a public network, such as the Internet, that interconnects client device 12 and visual search server 14. Commonly, network 16 implements various layers of the open system interconnection (OSI) model to facilitate transfer of communications or data between client device 12 and visual search server 14. Network 16 typically includes any number of network devices, such as switches, hubs, routers, servers, to enable the transfer of the data between client device 12 and visual search server 14. While shown as a single network, network 16 may comprise one or more sub-networks that are interconnected to form network 16. These sub-networks may comprise service provider networks, access networks, backend networks or any other type of network commonly employed in a public network to provide for the transfer of data throughout network 16. While described in this example as a public network, network 16 may comprise a private network that is not accessible generally by the public.

As shown in the example of FIG. 1, client device 12 includes a feature extraction unit 18, a feature compression unit 20, an interface 22 and a display 24. Feature extraction unit 18 represents a unit that performs feature extraction in accordance with a feature extraction algorithm, such as a compressed histogram of gradients (CHoG) algorithm or any other feature description extraction algorithm that extracts features in the form of a histogram and quantizes these histograms as types. Generally, feature extraction unit 18 operates on image data 26, which may be captured locally using a camera or other image capture device (not shown in the example of FIG. 1) included within client device 12. Alternatively, client device 12 may store image data 26 without capturing this image data itself by way of downloading this image data 26 from network 16, locally via a wired connection with another computing device or via any other wired or wireless form of communication.

While described in more detail below, feature extraction unit 18 may, in summary, extract a feature descriptor 28 by Gaussian blurring image data 26 to generate two consecutive Gaussian-blurred images. Gaussian blurring generally involves convolving image data 26 with a Gaussian blur function at a defined scale. Feature extraction unit 18 may incrementally convolve image data 26, where the resulting Gaussian-blurred images are separated from each other by a constant in the scale space. Feature extraction unit 18 then stacks these Gaussian-blurred images to form what may be referred to as a “Gaussian pyramid” or a “difference of Gaussian pyramid.” Feature extraction unit 18 then compares two successively stacked Gaussian-blurred images to generate difference of Gaussian (DoG) images. The DoG images may form what is referred to as a “DoG space.”

Based on this DoG space, feature extraction unit 18 may detect keypoints, where a keypoint refers to a region or patch of pixels around a particular sample point or pixel in image data 26 that is potentially interesting from a geometrical perspective. Generally, feature extraction unit 18 identifies keypoints as local maxima and/or local minima in the constructed DoG space. Feature extraction unit 18 then assigns these keypoints one or more orientations, or directions, based on directions of a local image gradient for the patch in which the keypoint was detected. To characterize these orientations, feature extraction unit 18 may define the orientation in terms of a gradient orientation histogram. Feature extraction unit 18 then defines feature descriptor 28 as a location and an orientation (e.g., by way of the gradient orientation histogram). After defining feature descriptor 28, feature extraction unit 18 outputs this feature descriptor 28 to feature compression unit 20. Feature extraction unit 18 may output a set of feature descriptors 28 using this process.

Feature compression unit 20 represents a unit that compresses or otherwise reduces an amount of data used to define feature descriptors, such as feature descriptors 28, relative to the amount of data used by feature extraction unit 18 to define these feature descriptors. To compress the feature descriptor, feature compression unit 20 may perform a form of quantization referred to as type quantization to compress feature descriptors 28. In this respect, rather than send the histograms defined by feature descriptors 28 in its entirety, feature compression unit 20 performs type quantization to represent the histogram as a so-called “type.” Generally, a type is a compressed representation of a histogram (e.g., where the type represents the shape of the histogram rather than the full histogram). The type generally represents a set of frequencies of symbols and, in the context of histograms, may represent the frequencies of the gradient distributions of the histogram. A type may, in other words, represent an estimate of the true distribution of the source that produced a corresponding one of feature descriptors 28. In this respect, encoding and transmission of the type may be considered equivalent to encoding and transmitting the shape of the distribution as it can be estimated based on a particular sample (i.e., which is the histogram defined by a corresponding one of feature descriptors 28 in this example).

Given feature descriptors 28 and a level of quantization (which may be mathematically denoted herein as “n”), feature compression unit 20 computes a type having parameters k₁, . . . , kₘ (where m denotes the number of dimensions) for each of feature descriptors 28. Each type may represent a set of rational numbers having a given common denominator, where the rational numbers sum to one. Feature descriptors 28 may then encode this type as an index using lexicographic enumeration. In other words, for all possible types having the given common denominator, feature compression unit 28 effectively assigns an index to each of these types based on a lexicographic ordering of these types. Feature compression unit 28 thereby compresses feature descriptors 28 into single lexicographically arranged indexes and outputs these compressed feature descriptors in the form of query data 30A, 30B to interface 22.

While described with respect to a lexicographically arrangement, the techniques may be employed with respect to any other type of arrangement so long as such an arrangement is provided for both the client device and the visual search server. In some instances, the client device may signal an arrangement mode to the visual search server, where the client device and the visual search server may negotiate an arrangement mode. In other instances, this arrangement mode may be statically configured in both the client device and the visual search server to avoid signaling and other overhead associated with performing the visual search.

Interface 22 represents any type of interface that is capable of communicating with visual search server 14 via network 16, including wireless interfaces and wired interfaces. Interface 22 may represent a wireless cellular interface and include the necessary hardware or other components, such as antennas, modulators and the like, to communicate via a wireless cellular network with network 16 and via network 16 with visual search server 14. In this instance, although not shown in the example of FIG. 1, network 16 includes the wireless cellular access network by which wireless cellular interface 22 communicates with network 16. Display 24 represents any type of display unit capable of displaying images, such as image data 26, or any other types of data. Display 24 may, for example, represent a light emitting diode (LED) display device, an organic LED (OLED) display device, a liquid crystal display (LCD) device, a plasma display device or any other type of display device.

Visual search server 14 includes an interface 32, a feature reconstruction unit 34, a feature matching unit 36 and a feature descriptor database 38. Interface 32 may be similar to interface 22 in that interface 32 may represent any type of interface capable of communicating with a network, such as network 16. Feature reconstruction unit 34 represents a unit that decompresses compressed feature descriptors to reconstruct the feature descriptors from the compressed feature descriptors. Feature reconstruction unit 34 may perform operations inverse to those performed by feature compression unit 20 in that feature reconstruction unit 34 performs the inverse of quantization (often referred to as reconstruction) to reconstruct feature descriptors from the compressed feature descriptors. Feature matching unit 36 represents a unit that performs feature matching to identify one or more features or objects in image data 26 based on reconstructed feature descriptors. Feature matching unit 36 may access feature descriptor database 38 to perform this feature identification, where feature descriptor database 38 stores data defining feature descriptors and associating at least some of these feature descriptors with identification data identifying the corresponding feature or object extracted from image data 26. Upon successfully identifying the feature or object extracted from image data 26 based on reconstructed feature descriptors, such as reconstructed feature descriptor 40A (which may also be referred to herein as “query data 40A” in that this data represents visual search query data used to perform a visual search or query), feature matching unit 36 returns this identification data as identification data 42.

Initially, a user of client device 12 interfaces with client device 12 to initiate a visual search. The user may interface with a user interface or other type of interface presented by display 24 to select image data 26 and then initiate the visual search to identify one or more features or objects that are the focus of the image stored as image data 26. For example, image data 26 may specify an image of a piece of famous artwork. The user may have captured this image using an image capture unit (e.g., a camera) of client device 12 or, alternatively, downloaded this image from network 16 or, locally, via a wired or wireless connection with another computing device. In any event, after selecting image data 26, the user initiates the visual search to, in this example, identify the piece of famous artwork by, for example, name, artist and date of completion.

In response to initiating the visual search, client device 12 invokes feature extraction unit 18 to extract at least one feature descriptor 28 describing one of the so-called “keypoints” found through analysis of image data 26. Feature extraction unit 18 forwards this feature descriptor 28 to feature compression unit 20, which proceeds to compress feature descriptor 28 and generate query data 30A. Feature compression unit 20 outputs query data 30A to interface 22, which forwards query data 30A via network 16 to visual search server 14.

Interface 32 of visual search server 14 receives query data 30A. In response to receiving query data 30A, visual search server 14 invokes feature reconstruction unit 34. Feature reconstruction unit 34 attempts to reconstruct feature descriptors 28 based on query data 30A and outputs reconstructed feature descriptors 40A. Feature matching unit 36 receives reconstructed feature descriptors 40A and performs feature matching based on feature descriptors 40A. Feature matching unit 36 performs feature matching by accessing feature descriptor database 38 and traversing feature descriptors stored as data by feature descriptor database 38 to identify a substantially matching feature descriptor. Upon successfully identifying the feature extracted from image data 26 based on reconstructed feature descriptors 40A, feature matching unit 36 outputs identification data 42 associated with the feature descriptors stored in feature descriptor database 38 that matches to some extent (often expressed as a threshold) reconstructed feature descriptors 40A. Interface 32 receives this identification data 42 and forwards identification data 42 via network 16 to client device 12.

Interface 22 of client device 12 receives this identification data 42 and presents this identification data 42 via display 24. That is, interface 22 forwards identification data 42 to display 24, which then presents or displays this identification data 42 via a user interface, such as the user interface used to initiate the visual search for image data 26. In this instance, identification data 42 may comprise a name of the piece of artwork, the name of the artist, the data of completion of the piece of artwork and any other information related to this piece of artwork. In some instances, interface 22 forwards identification data to a visual search application executing within client device 12, which then uses this identification data (e.g., by presenting this identification data via display 24).

While various components, modules, or units are described in this disclosure to emphasize functional aspects of devices configured to perform the disclosed techniques, these units do not necessarily require realization by different hardware units. Rather, various units may be combined in a hardware unit or provided by a collection of inter-operative hardware units, including one or more processors as described above, in conjunction with suitable software and/or firmware stored to computer-readable mediums. In this respect, reference to units in this disclosure is intended to suggest different functional units that may or may not be implemented as separate hardware units and/or hardware and software units.

In performing this form of networked visual search, client device 12 consumes power or energy, which is often limited in the mobile or portable device context in the sense that these devices employ batteries or other energy storage devices to enable portability, extracting feature descriptors 28 and then compressing these feature descriptors 28 to generate query data 30A. In some instances, feature compression unit 20 may not be invoked to compress feature descriptors 28. For example, client device 12 may not invoke feature compression unit 20 upon detecting that available power or energy is below a certain threshold of available power, such as 20% of available power. Client device 12 may provide these thresholds to balance bandwidth consumption with power consumption.

Commonly, bandwidth consumption is a concern for mobile devices that interface with a wireless cellular access network because these wireless cellular access networks may provide only a limited amount of bandwidth for a fixed fee or, in some instances, charge for each kilobyte of bandwidth consumed. If compression is not enabled, such as when the above noted threshold is exceeded, client device 12 sends feature descriptors 28 as query data 30A without first compressing feature descriptors 28. While avoiding compression may conserve power, sending uncompressed feature descriptors 28 as query data 30A may increase the amount of bandwidth consumed, which in turn may increase costs associated with performing the visual search. In this sense, both power and bandwidth consumption are a concern when performing networked visual search.

Another concern associated with networked visual search is latency. Commonly, feature descriptors 28 are defined as a 128 element vector that has been derived from 16 histograms with each of these histograms having 8 bins. Compression of feature descriptors 28 may reduce latency in that communicating less data generally takes less time than communicating relatively more data. While compression may reduce latency in terms of the total time to send feature descriptors 28, network 16 introduces latency in terms of the amount of time network 16 takes to transmit feature descriptors 28 from client device 12 to visual search server 14. This latency may reduce or otherwise negatively impact a user's experience, especially if a large amount of latency is introduced, such as when a number of feature descriptors are required to positively identify one or more objects of the image. In some instances, rather than continue performing the visual search by requiring additional feature descriptors that insert additional delay, visual search server 14 may stop or otherwise halt the visual search and return information data 42 indicating that the search has failed.

In accordance with the techniques described in this disclosure, feature compression unit 20 of client device 12 performs a form of feature descriptor compression that involves successive refinable quantization of feature descriptors 28. In other words, rather than send image data 26 in its entirety, uncompressed feature descriptors 28 or even feature descriptors 28 quantized at a given pre-determined quantization level (usually arrived at by way of experimentation), the techniques generate query data 30A representative of feature descriptors 28 quantized at a first quantization level. This first quantization level is generally less fine or complete than the given pre-determined quantization level conventionally employed to quantize feature descriptors, such as feature descriptors 28.

Feature compression unit 20 may then determine query data 30B in a manner that augments query data 30A such that, when query data 30A is updated with query data 30B, updated first query data 30A is representative of feature descriptors 28 quantized at a second quantization level that achieves a more complete representation of feature descriptors 28 (i.e., a lower degree of quantization) than that achieved when quantized at the first quantization level. In this sense, feature compression unit 20 may successively refine the quantization of feature descriptors 28 in that first query data 30A can be generated and then successively updated with second query data 30B to achieve a more complete representation of feature descriptors 28.

Considering that query data 30A represents feature descriptors 28 quantized at a first quantization level that is generally not as fine as that used to quantize feature descriptors conventionally, query data 30A formulated in accordance with the techniques may be smaller in size than conventionally quantized feature descriptors, which may reduce bandwidth consumption while also improving latency. Moreover, client device 12 may transmit query data 30A while determining query data 30B that augments query data 30B. Visual search server 16 may then receive query data 30A and begin the visual search also concurrently with determination of query data 30B by client device 12. In this way, latency may be greatly reduced due to the concurrent nature of performing the visual search while determining query data 30B that augments query data 30A.

In operation, client device 12 stores image data 26 defining a query image, as noted above. Feature extraction unit 18 extracts image feature descriptors 28 from image data 26 that defines features of the query image. Feature compression unit 20 then implements the techniques described in this disclosure to quantize feature descriptors 28 at a first quantization level to generate first query data 30A representative of feature descriptors 28 quantized at the first quantization level. First query data 30A is defined in such a manner as to enable successive augmentation of first query data 30A when updated by second query data 30B. Feature compression unit 20 forwards this query data 30A to interface 22, which transmits query data 30A to visual search server 14. Interface 32 of visual search server 14 receives query data 30A, whereupon visual search server 14 invokes feature reconstruction unit 34 to reconstruct feature descriptor 28. Feature reconstruction unit 34 then outputs reconstructed feature descriptors 40A. Feature matching unit 36 then performs the visual search by accessing feature descriptor database 38 based on reconstructed feature descriptors 40A.

Concurrent to feature matching unit 36 performing the visual search using reconstructed feature descriptors 40A, feature compression unit 20 determines second query data 30B that augments first query data 30A such that, when first query data 30A is updated with second query data 30B, updated first query data 30A is representative of feature descriptors 28 quantized at the second quantization level. Again, this second quantization level achieves a finer or more complete representation of feature descriptors 28 than that achieved when quantizing at the first quantization level. Feature compression unit 20 then outputs query data 30B to interface 22, which transmits second query data 30B to visual search server 14 via network 16 to successively refine first query data 30A.

Interface 32 of visual search server 14 receives second query data 30B, whereupon visual search server 14 invokes feature reconstruction unit 34. Feature reconstruction unit 34 may then reconstruct feature descriptors 28 at a finer level by updating first query data 30A with second query data 30B to generate reconstructed feature descriptors 40B (which, again, may be referred to as “updated query data 40B” in that this data concerns a visual search or query data used to perform a visual search or query). Feature matching unit 36 may then reinitiate the visual search using updated query data 40B rather than query data 40A.

Although not shown in the example of FIG. 1, this process of successively refining feature descriptors 28 using finer and finer quantization levels and then reinitiating the visual search may continue either until feature matching unit 36 positively identifies one or more objects and features extracted from image data 26, determines this feature or object cannot be identified, or otherwise reaches a power consumed, latency or other threshold that may terminate the visual search process. For example, client device 12 may determine that it has sufficient power to refine feature descriptors 28 yet another time by, as an example, comparing a currently determined amount of power to a power threshold.

In response to this determination, client device 12 may invoke feature compression unit 20 to, concurrent to this reinitiated visual search, determine third query data that augments second query data 30B such that, when query data 40B is updated with this third query data, this updated second query data results in a reconstructed feature descriptors that has been quantized at a third, even finer quantization level than the second quantization level. Visual search server 14 may receive this third query data and re-initiate the visual search with respect to this same feature descriptors although quantized at the third quantization level.

Thus, unlike conventional systems that perform a visual search based on a first set of feature descriptors and then based on successive different feature descriptors (in that they are typically different from the first feature descriptor or are extracted from and therefore describe a different image entirely), the techniques described in this disclosure initiate a visual search for feature descriptors quantized at a first quantization level and then re-initiate the visual search for the same feature descriptors although quantized at a second different and usually finer or more complete quantization level. This process may continue on an iterative basis, as discussed above, such that successive versions of the same feature descriptors are quantized at successively lesser degrees, i.e., from coarse feature descriptor data to finer feature descriptor data. By transmitting query data 30A in sufficient detail to, in some instances, initiate the visual search while concurrently determining second query data 30B that enables re-initiation of the visual search (although with respect to query data 40B more finely or completely quantized than first query data 40A), the techniques may improve latency considering that the visual search is performed concurrently to quantization.

In some instances, the techniques may terminate after only providing the coarsely quantized first query data to the visual search server, assuming the visual search server is able to identify the features based on this coarsely quantized first query data to some acceptable degree. In this instance, the client device need not successively quantize the feature descriptors to provide the second query data that defines sufficient data to enable the visual search server to reconstruct the feature descriptors at a second, finer degree of quantization. In this way, the techniques may improve latency over conventional techniques, in that the techniques provide a more coarsely quantized feature descriptors that may require less time to determine than the more finely quantized feature descriptors common in conventional systems. As a result, the visual search server may identify the feature more quickly over conventional systems.

Moreover, query data 30B does not repeat any data from query data 30A that is then used as a basis to perform the visual search. In other words, query data 30B augments query data 30A and does not replace any portion of query data 30A. In this respect, the techniques may not consume much more bandwidth in network 16 than sending conventionally quantized feature descriptors 28 (assuming the second quantization level employed by the techniques is approximately equal to that employed conventionally). The only increase in bandwidth consumption occurs because both of query data 30A, 30B require packet headers to traverse network 12 and other insubstantial amounts of meta data, which conventionally are not required because any given feature descriptor is only quantized and sent once. Yet, this bandwidth increase is typically minor compared to the decreases in latency enabled through application of the techniques described in this disclosure.

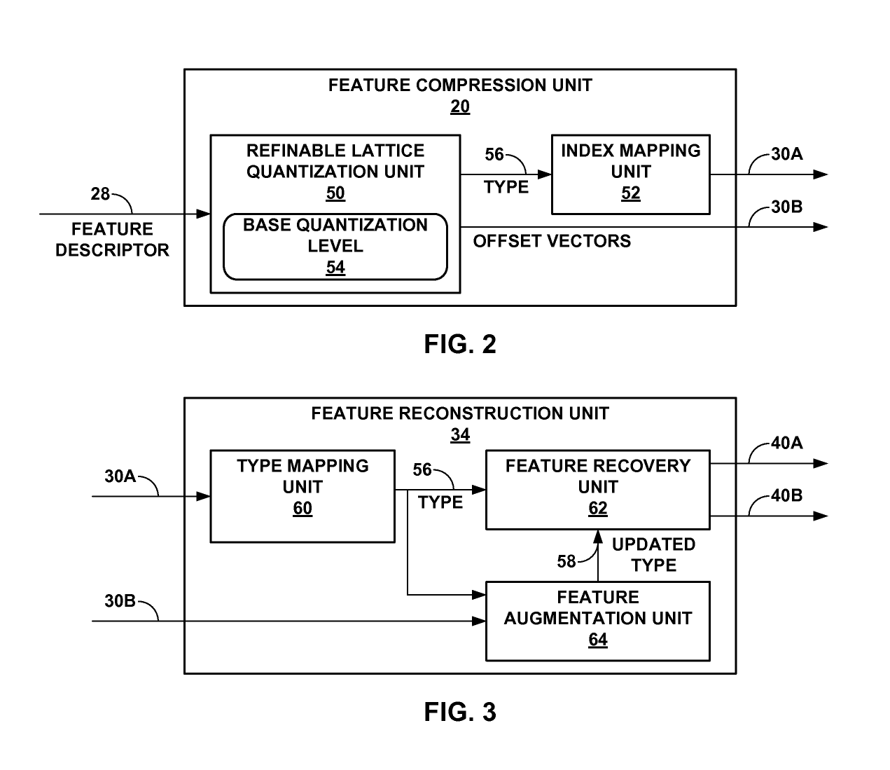

FIG. 2 is a block diagram illustrating feature compression unit 20 of FIG. 1 in more detail. As shown in the example of FIG. 2, feature compression unit 20 includes a refinable lattice quantization unit 50 and an index mapping unit 52. Refinable lattice quantization unit 50 represents a unit that implements the techniques described in this disclosure to provide for successive refinement of feature descriptors. Refinable lattice quantization unit 50 may, in addition to implementing the techniques described in this disclosure, also perform a form of lattice quantization that determines the above described type.

When performing lattice quantization, refinable lattice quantization unit 50 first computes lattice points k′₁ . . . , k′ₘ based on base quantization level 54 (which may be referred to mathematically as n) and feature descriptors 28. Refinable lattice quantization unit 50 then sums these points to determine n′ and compares n′ to n. If n′ is equal to n, refinable lattice quantization unit 50 sets kᵢ (where i=1, . . . , m) to k′ᵢ. If n′ is not equal to n, refinable lattice quantization unit 50 computes errors as a function of k′ᵢ, n and feature descriptors 28 and then sorts these errors. Refinable lattice quantization unit 50 then determines whether n′ minus n is greater than zero. If n′ minus n is greater than zero, refinable lattice quantization unit 50 decrements those k′ᵢ values having the largest errors by one. If n′ minus n is greater than zero, refinable lattice quantization unit 50 increments those of the k′ᵢ values having the smallest errors by one. If incremented or decremented in this manner, refinable lattice quantization unit 50 sets kᵢ to the adjusted k′ᵢ values. Refinable lattice quantization unit 50 then outputs these kᵢ values as type 56 to index mapping unit 52.

Index mapping unit 52 represents a unit that uniquely maps type 56 to an index. index mapping unit 52 may mathematically compute this index as an index that identifies type 56 in a lexicographic arrangement of all possible types computed for a feature descriptor (which again is expressed as a probability distribution in the form of a histogram) of the same dimension as that for which type 56 was determined. Index mapping unit 52 may compute this index for type 56 and output this index as query data 30A.

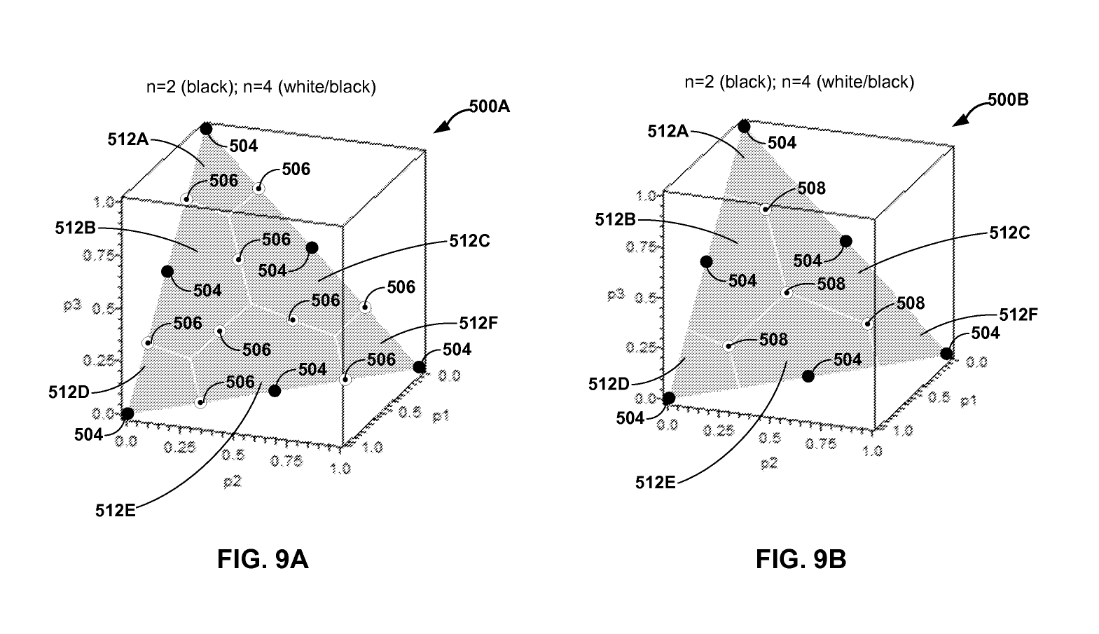

In operation, refinable lattice quantization unit 50 receives feature descriptors 28 and computes type 56 having k₁, . . . , kₘ parameters. Refinable lattice quantization unit 50 then outputs type 56 to index mapping unit 52. Index mapping unit 52 maps type 56 to an index that uniquely identifies type 56 in the set of all types possible for a feature descriptor having dimensionality m. Index mapping unit 52 then outputs this index as query data 30A. This index may be considered to represent a lattice of reconstruction points located at the center of Voronoi cells uniformly defined across the probability distribution, as shown and described in more detail with respect to FIGS. 9A, 9B. As noted above, visual search server 14 receives query data 30A, determines reconstructed feature descriptors 40A and performs a visual search based on reconstructed feature descriptors 40A. While described with respect to Voronoi cells, the techniques may be implemented with respect to any other type of uniform or non-uniform cell capable of facilitating the segmenting of a space to enable a similar sort of index mapping.

Typically, while query data 30A is in transit between client and server 14 and/or while visual search server 14 determines reconstructed feature descriptors 40A and/or performs the visual search based on reconstructed feature descriptors 40A, refinable lattice quantization unit 50 implements the techniques described in this disclosure to determine query data 30B in such a manner that, when query data 30A is augmented by query data 30B, augmented or updated query data 30A represents feature descriptors 28 quantized at a finer quantization level than the base or first quantization level. Refinable lattice quantization unit 50 determines query data 30B as one or more offset vectors that identify offsets from reconstruction points q₁, . . . , qₘ, which are a function of type parameters k₁, . . . , kₘ (i.e.,

$$q = [ \frac{{k}_{1}}{n} , … , \frac{{k}_{m}}{n} ] ) .$$

Refinable lattice quantization unit 50 determines query data 30B in one of two ways. In a first way, refinable lattice quantization unit 50 determines query data 30B by doubling the number of reconstruction points used to represent feature descriptors 28 with query data 30A. In this respect, the second quantization level may be considered as double that of first or base quantization level 54. With respect to the example lattice shown in the example of FIG. 9A, these offset vectors may identify additional reconstruction points as the center of the faces of each of the Voronoi cells. As described in more detail below, while doubling the number of reconstruction points and thereby defining feature descriptors 28 with more granularity, this first way of successively quantizing feature descriptors 28 may require that base quantization level 54 is defined such that it is sufficiently larger than the dimensionality of the probability distribution expressed as a histogram in this example (i.e., that n is defined larger than m) to avoid introduction too much overhead (and thereby bandwidth consumption) in terms of the number of bits required to send these vectors in comparison to just sending the lattice of reconstruction points at the second higher quantization level.

While in most or at least some instances, base quantization level 54 can be defined larger than the dimensionality of the probability distribution (or histogram in this example), in some instances, base quantization level 54 cannot be defined sufficiently larger than the dimensionality of the probability distribution. In these instances, refinable lattice quantization unit 50 may alternatively compute offset vectors in accordance with the second way using a dual lattice. That is, rather than double the number of reconstruction points defined by query data 30A, refinable lattice quantization unit 50 determines offset vectors so as to fill the holes in the lattice of reconstruction points expressed as query data 30A by way of the index mapped by index mapping unit 52. Again, this augmentation is shown and described in more detail with respect to the example of FIG. 9B. Considering that these offset vectors define an additional lattice of reconstruction points that fall at the intersections or vertices of the Voronoi cells, these offset vectors expressed as query data 30B may be considered to define yet another lattice of reconstruction points in addition to the lattice of reconstruction points expressed by query data 30A; hence, this leads to the characterization that this second way employs a dual lattice.

While this second way of successively refining the quantization level of feature descriptor 28 does not require that base quantization level 54 be defined substantially larger than the dimensionality of the underlying probability distribution, this second way may be more complex in terms of the number of operations required to compute the offset vectors. Considering that performing additional operations may increase power consumption, in some examples, this second way of successively refining the quantization of feature descriptors 28 may only be employed when sufficient power is available. Power sufficiency may be determined with respect to a user-defined, application-defined or statically-defined power threshold such that refinable lattice quantization unit 50 only employs this second way when the current power exceeds the this threshold. In other instances, refinable lattice quantization unit 50 may always employ this second way to avoid the introduction of overhead in those instances where the base level of quantization cannot be defined sufficiently large enough in comparison to the dimensionality of the probability distribution. Alternatively, refinable lattice quantization unit 50 may always employ the first way to avoid the implementation complexity and resulting power consumption associated with the second way.

FIG. 3 is a block diagram illustrating feature reconstruction unit 34 of FIG. 1 in more detail. As shown in the example of FIG. 3, feature reconstruction unit 34 includes a type mapping unit 60, a feature recovery unit 62 and a feature augmentation unit 64. Type mapping unit 60 represents a unit that performs the inverse of index mapping unit 52 to map the index of query data 30A back to type 56. Feature recovery unit 62 represents a unit that recovers feature descriptors 28 based on type 56 to output reconstructed feature descriptors 40A. Feature recovery unit 62 performs the inverse operations to those described above with respect to refinable lattice quantization unit 50 when reducing feature descriptors 28 to type 56. Feature augmentation unit 64 represents a unit that receives offset vectors of query data 30B and augments type 56 through the addition of reconstruction to the lattice of reconstruction points defined by type 56 based on offset vectors. Feature augmentation unit 64 applies offset vectors of query data 30B to the lattice of reconstruction points defined by type 56 to determine additional reconstruction points. Feature augmentation unit 64 then updates type 56 with these determined additional reconstruction points, outputting an updated type 58 to feature recovery unit 62. Feature recovery unit 62 then recovers feature descriptors 28 from updated type 58 to output reconstructed feature descriptors 40B.

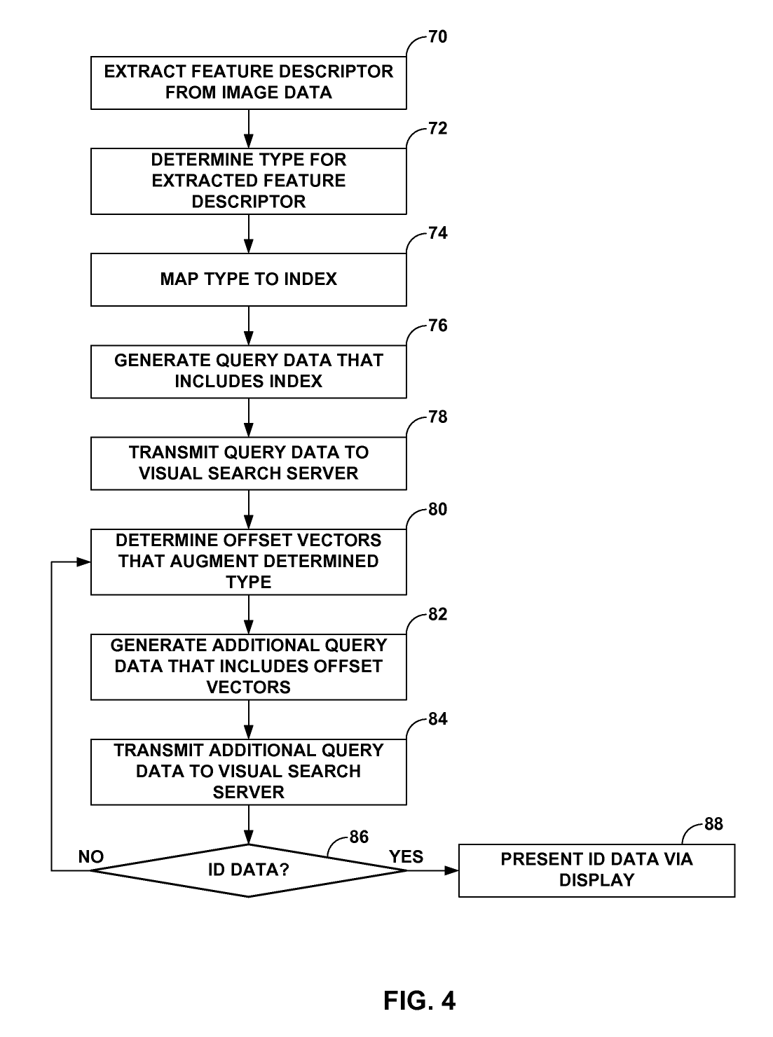

FIG. 4 is a flowchart illustrating exemplary operation of a visual search client device, such as client device 12 shown in the example of FIG. 1, in implementing the successively refinable quantization techniques described in this disclosure. While described with respect to a particular device, i.e., client device 12, the techniques may be implemented by any device capable of performing mathematical operations with respect to a probability distribution so as to reduce latency in further uses of this probability distribution, such as for performing a visual search. In addition, while described in the context of a visual search, the techniques may be implemented in other contexts to facilitate the successive refinement of a probability distribution.

Initially, client device 12 may store image data 26. Client device 12 may include a capture device, such as an image or video camera, to capture image data 26. Alternatively, client device 12 may download or otherwise receive image data 26. A user or other operator of client device 12 may interact with a user interface provided by client device 12 (but not shown in the example of FIG. 1 for ease of illustration purposes) to initiate a visual search with respect to image data 26. This user interface may comprise a graphical user interface (GUI), a command line interface (CLI) or any other type of user interface employed for interfacing with a user or operator of a device.

In response to the initiation of the visual search, client device 12 invokes feature extraction unit 18. Once invoked, feature extraction unit 18 extracts feature descriptor 28 from image data 26 in the manner described in this disclosure (70). Feature extraction unit 18 forwards feature descriptor 28 to feature compression unit 20. Feature compression unit 20, which is shown in the example of FIG. 2A in more detail, invokes refinable lattice quantization unit 50. Refinable lattice quantization unit 50 reduces feature descriptor 28 to type 56 through quantization of feature descriptor 28 at base quantization level 54. This feature descriptor 28, as noted above, represents a histogram of gradients, which is a specific example of the more general probability distribution. Feature descriptor 28 may be represented mathematically as the variable p.

Feature compression unit 20 performs a form of type lattice quantization to determine a type for extracted feature descriptor 28 (72). This type may represent a set of reconstruction points or centers in a set of reproducible distributions represented mathematically by the variable Q, where Q may be considered as a subset of a set of probability distributions (Ωₘ) over a discrete set of events (A). Again, the variable m refers to the dimensionality of the probability distributions. Q may be considered as a lattice of reconstruction points. The variable Q may be modified by a variable n to arrive at Qₙ, which represents a lattice having a parameter n defining a density of points in the lattice (which may be considered a level of quantization to some extent). Qₙ may be mathematically defined by the following equation (1):

$${Q}_{n} = \{ [ {q}_{1} , … , {q}_{n} ] ∈ {Q}^{m} \vert {q}_{i} = \frac{{k}_{i}}{n} , {\sum }_{i} {k}_{i} = n \} , … , n , \\ {k}_{1} , … , {k}_{m} ∈ {Z}^{+} . \qquad ( 1 )$$

In equation (1), the elements of Qₙ are denoted as q₁, . . . , qₘ. The variable Z⁺ represents all positive integers.

For a lattice having a given m and n, the lattice Qₙ may contain the number of points expressed mathematically by the following equation (2):

$$\vert {Q}_{n} \vert = ( \begin{matrix}n + m - 1 \\ m - 1\end{matrix} ) . \qquad ( 2 )$$

Also, the coverage radii for this type of lattice, expressed in terms of L-norm-based maximum distances, are those expressed in the following equations (3)-(5):

$$\begin{matrix}{max}_{p ∈ {Ω}_{m}} {min}_{p ∈ {Q}_{n}} {d}_{∞} ( p , q ) = \frac{1}{n} ( 1 - \frac{1}{m} ) , & ( 3 ) \\ {max}_{p ∈ {Ω}_{m}} {min}_{q ∈ {Q}_{n}} {d}_{2} ( p , q ) = \frac{1}{n} \sqrt{\frac{a ( m - a )}{m}} , & ( 4 ) \\ {max}_{p ∈ {Ω}_{m}} {min}_{q ∈ {Q}_{n}} {d}_{1} ( p , q ) = \frac{1}{n} \frac{2 a ( m - a )}{m} . & ( 5 )\end{matrix}$$

In the above equations (3)-(5), the variable a may be expressed mathematically by the following equation (6):

a=└m/2┘. (6)

In addition, the direct (non-scalable or non-refinable) transmission of type indices results in the following radius/rate characteristics of the quantizer, as expressed mathematically by the following equations (7)-(9):

$$\begin{matrix}{d}_{∞}^{*} [ {Q}_{n} ] ( {Ω}_{m} , R ) \sim {2}^{- \frac{R}{m - 1}} \frac{1 - \frac{1}{m}}{\sqrt[m - 1]{( m - 1 ) !}} , & ( 7 ) \\ {d}_{2}^{*} [ {Q}_{n} ] ( {Ω}_{m} , R ) \sim {2}^{- \frac{R}{m - 1}} \frac{\sqrt{\frac{a ( m - a ) }{m}}}{\sqrt[m - 1]{( m - 1 ) !}} , & ( 8 ) \\ {d}_{1}^{*} [ {Q}_{n } ] ( {Ω}_{m} , R ) \sim {2}^{- \frac{R}{m - 1}} \frac{\frac{2 a ( m - a )}{m}}{\sqrt[m - 1]{( m - 1 ) !}} . & ( 9 )\end{matrix}$$

To produce this set of reconstruction points or the so-called “type” at given base quantization level 54 (which may represent the variable n noted above), refinable lattice quantization unit 50 first computes values in accordance with the following equation (10):

$${k}_{i}^{′} = ⌊ {np}_{i} + \frac{1}{2} ⌋ , {n}^{′} = {\sum }_{i} {k}_{i}^{′} . \qquad ( 10 )$$

The variable i in equation (10) represents the set of values from 1, . . . , m. If n′ equals n, the nearest type is given by kᵢ=k′ᵢ. Otherwise, if n′ does not equal n, refinable lattice quantization unit 50 computes errors δᵢ in accordance with the following equation (11):

δᵢ=k′ᵢ−npᵢ, (11)

and sorts these errors such that the following equation (12) is satisfied:

$$- \frac{1}{2} , , {δ}_{{j}_{1}} , , {δ}_{{j}_{2}} , , … , , {δ}_{{j}_{m}} , , \frac{1}{2} . \qquad ( 12 )$$

Refinable lattice quantization unit 50 then determines the difference between n′ and n, where such difference may be denoted by the variable Δ and expressed by the following equation (13):

Δ=n′−n. (13)

If Δ is greater than zero, refinable lattice quantization unit 50 decrements those values of k′ᵢ with the largest errors, which may be expressed mathematically by the following equation (14):

$${k}_{{j}_{i}} = [ \begin{matrix}{k}_{{j}_{i}}^{′} & j = i , … , m - Δ - 1 , \\ {k}_{{j}_{i }}^{′} - 1 & i = m - Δ , … , m ,\end{matrix} \qquad ( 14 )$$

However, if Δ is determined to be less than zero, refinable lattice quantization unit 50 increments those values of k′ᵢ having the smallest errors, which may be expressed mathematically by the following equation (15):

$${k}_{{j}_{i}} = [ \begin{matrix}{k}_{{j}_{i}}^{′} + 1 & i = 1 , … , \vert Δ \vert , \\ {k}_{{j}_{i}}^{′} & i = \vert Δ \vert + 1 , … , m .\end{matrix} \qquad ( 15 )$$

Given that the base level of quantization or n is known, rather than express the type in terms of q₁, . . . , qₘ, refinable lattice quantization unit 50 expresses type 56 as a function of k₁, . . . , kₘ, as computed via one of the three ways noted above. Refinable lattice quantization unit 50 outputs this type 56 to index mapping unit 52.

Index mapping unit 52 maps this type 56 to an index (74), which is included in query data 30A. To map this type 56 to the index, index mapping unit 52 may implement the following equation (16), which computes an index ξ(k₁, . . . , kₘ) assigned to type 56 that indicates the lexicographical arrangement of type 56 in a set of all possible types for probability distributions having a dimensionality m:

$$ξ ( {k}_{1} , … , {k}_{n} ) = {\sum }_{j = 1}^{n - 2} {\sum }_{i = 0}^{{k}_{j} - 1} ( \begin{matrix}n - i - {\sum }_{l = 1}^{j - 1} {k}_{l} + m - j - 1 \\ m - j - 1\end{matrix} ) + {k}_{n - 1} . \qquad ( 16 )$$

Index mapping unit 56 may implement this equation using a pre-computed array of binomial coefficients. Index mapping unit 52 then generates query data 30A that includes the determined index (76). Client device 12 then transmits this query data 30A via network 16 to visual search server 14 (78).

Concurrent to index mapping unit 52 determining the index and/or client device 12 transmitting query data 30A and/or visual search server 14 performing the visual search based on query data 30A, refinable lattice quantization unit 50 determines offset vectors 30B that augment the previously determined type 56 such that, when type 56 is updated with offset vectors 30B, this updated or augmented type 56 may express feature descriptors 28 at a finer level of quantization than that used to quantize type 56 as included within query data 30A (80). Refinable lattice quantization unit 50, as noted above, initially receives lattice Qₙ in the form of type 56. Refinable lattice quantization unit 50 may implement one or both of two ways of computing offset vectors 30B.

In the first way, refinable lattice quantization unit 50 doubles base quantization level 54 or n to result in a second finer level of quantization that can be expressed mathematically as 2n. The lattice produced using this second finer level of quantization may be denoted as Q₂ₙ, where the points of lattice Q₂ₙ are related to the points of lattice Qₙ in the manner defined by the following equation (17):

$$[ \frac{2 {k}_{1} + {δ}_{1}}{2 n} , … , \frac{2 {k}_{m} + {δ}_{m}}{2 n} ] , \qquad ( 17 )$$

where δ₁, . . . , δₘε{−1,0,1}, such that δ₁+ . . . +δₘ=0. An evaluation of this way of computing offset vectors 30B begins by considering the number of points that may be inserted around a point in the original lattice Qₙ. The number of points may be computed in accordance with the below equation (18), where k₋₁, k₀, k₁ denote the numbers of occurrences of values −1,0,1 among elements of a displacement vector [δ₁, . . . , δₘ]. Given that the condition where δ₁+ . . . +δₘ=0 implies that k₋₁=k₁, the number of points may be computed by the following equation (18):

$$η ( m ) = {\sum }_{{k = 0 … ⌊ m / 2 ⌋}_{{k}_{- 1} = {k}_{1} = k ; {k}_{0} = n - 2 k ;}} ( \begin{matrix}m \\ {k}_{- 1} , {k}_{0} , {k}_{1}\end{matrix} ) = {\sum }_{k = 0 … ⌊ m / 2 ⌋} \frac{m !}{{( k ! )}^{2} ( n - 2 k ) !} . \qquad ( 18 )$$

From equation (18), it can be determined that asymptotically (with large m) this number of points grows as η(m)˜αm!, where α≈2.2795853.

To encode a vector [δ₁, . . . , δₘ] needed to specify a position of a type in lattice Q₂ₙ relative to lattice Qₙ, the number of bits required at most may be derived using the following equation (19):

$$log η ( m ) \sim m log ( m ) - m log e + \frac{1}{2} log m + log ( \sqrt{2 π} α ) + O ( \frac{1}{m} ) . \qquad ( 19 )$$

Comparing this measure of the number of bits required to send the offset vector to the number of bits required to send a direct encoding of a point in Q₂ₙ results in the following equation (20):

$$\frac{log ( \begin{matrix}n + m - 1 \\ m - 1\end{matrix} ) + log η ( m )}{log ( \begin{matrix}2 n + m - 1 \\ m - 1\end{matrix} )} \sim 1 + \frac{log m - 1 - log 2 + O ( \frac{log m}{m} )}{log n} + O ( \frac{1}{{( log n )}^{2}} ) . \qquad ( 20 )$$

Considering equation (20) generally, it can be observed that, in order to ensure small overhead of incremental transmission of type indices, this first way should start with a direct transmission of an index from lattice Qₙ in which n is much larger (>>) than m. This condition on implementing the first way may not always be practical.

Refinable lattice quantization unit 50 may alternatively implement a second way that is not bounded by this condition. This second way involves augmenting Qₙ with points placed in the holes or vertices of Voronoi cells, where the resulting lattice may be denoted as Qₙ*, which is defined in accordance with the following equation (21):

$${Q}_{n}^{*} = {⋃}_{i = 0 … m - 1} {Q}_{n} + {v}_{i} . \qquad ( 21 )$$

This lattice Qₙ* may be referred to as a “dual type lattice” in this disclosure. The variable vᵢ represent vectors indicating the offset to vertices of Voronoi cells, which may be expressed mathematically in accordance with the following equation (22):

$${v}_{i} = \frac{1}{n} [ \underbrace{\frac{m - i}{m} , … , \frac{m - i}{m}}_{i times} , \underbrace{\frac{- i}{m} , … , \frac{- i}{m}}_{m - i times} ] , \\ i = 1 , … m - 1. \qquad ( 22 )$$

Each vector vᵢ allows for (ᵢ^{m}) permutations of its values. Given this number of permutations, the total number of points inserted around a point in Qₙ by converting it to a dual type lattice Qₙ*, satisfies the equation set forth in the following equation (23):

$$κ ( m ) = {{\sum }_{i = 1}}^{m - 1} ( \begin{matrix}m \\ i\end{matrix} ) {2}^{m} - 2. \qquad ( 23 )$$

Given equation (23), the encoding of a point in a dual type lattice Qₙ*, relative to a known position of a point in lattice Qₙ can be accomplished by transmitting at most the number of bits expressed in the following equation (24):

log κ(m)˜m+O(1/m) (24)

In evaluating this second way of determining offset vectors 30B, an estimate of the reduction in covering radius, when switching from lattice Qₙ to Qₙ*, is required. For a type lattice Qₙ, the following equation (25) expresses the radius coverage (d₂*):

$${d}_{2}^{*} ( {Q}_{n} ) = {max}_{p ∈ {Ω}_{m}} {min}_{q ∈ {Q}_{n}} {‖ p - q ‖}_{2} = \frac{1}{n} \sqrt{\frac{⌊ m / 2 ⌋ ( m - ⌊ m / 2 ⌋ )}{m}} \sim \frac{1}{2 n} \sqrt{m} , \qquad ( 25 )$$

while, for the dual type lattice Qₙ*, the following equation (26) expresses the radius coverage:

$${d}_{2}^{*} ( {Q}_{n}^{*} ) = {max}_{p ∈ {Ω}_{m}} {min}_{q ∈ {Q}_{n }^{*}} {‖ p - q ‖}_{2} = \frac{1}{n} \sqrt{\frac{( m - 1 ) ( m + 1 )}{12 m}} \sim \frac{1}{2 \sqrt{3} n} \sqrt{m} . \qquad ( 26 )$$

Comparing these two different radius coverage values, it can be determined that transitioning from lattice Qₙ to Qₙ* reduces covering radius by a factor of \sqrt{3}˜1.732, while causing about m bits rate of overhead. The efficiency of this second way of coding compared to non-refinable Qₙ a lattice based coding can be estimated in accordance with the following equation (27):

$$\frac{log ( \begin{matrix}n + m - 1 \\ m - 1\end{matrix} ) + log κ ( m )}{log ( \begin{matrix}\sqrt{3} n + m - 1 \\ m - 1\end{matrix} )} \sim 1 + \frac{log ( 2 / \sqrt{3} ) + O ( \frac{1}{m} )}{log n} + O ( \frac{1}{{( log n )}^{2}} ) . \qquad ( 27 )$$

From equation (27), it can be observed this second way of coding is decreasing with base quantization level of the starting lattice (i.e., as defined by parameter n in this example), but this parameter n does not have to be relatively large with respect to the dimensionality m. Refinable lattice quantization unit 50 may utilize either or both of these two ways of determining the offset vectors 30B with respect to previously determined type 56.

Refinable lattice quantization unit 50 then generates additional query data 30B that includes these offset vectors (82). Client device 12 transmits query data 30B to visual search server 12 in the manner described above (84). Client device 12 may then determine whether it has received identification data 42 (86). If client device 12 determines it has not yet received identification data 42 (“NO” 86), client device 12 may continue in some examples to further refine augmented type 56 by determining additional offset vectors that augment already augmented type 56 using either of the two ways described above, generate third query data that includes these additional offset vectors and transmit this third query data to visual search server 14 (80-84). This process may continue in some examples until client device 12 receives identification data 42. In some examples, client device 12 may only continue to refine type 56 past the first refinement when client device 12 has sufficient power to perform this additional refinement, as discussed above. In any event, if client device 12 receives identification data 42, client device 12 presents this identification data 42 to the user via display 24 (88).

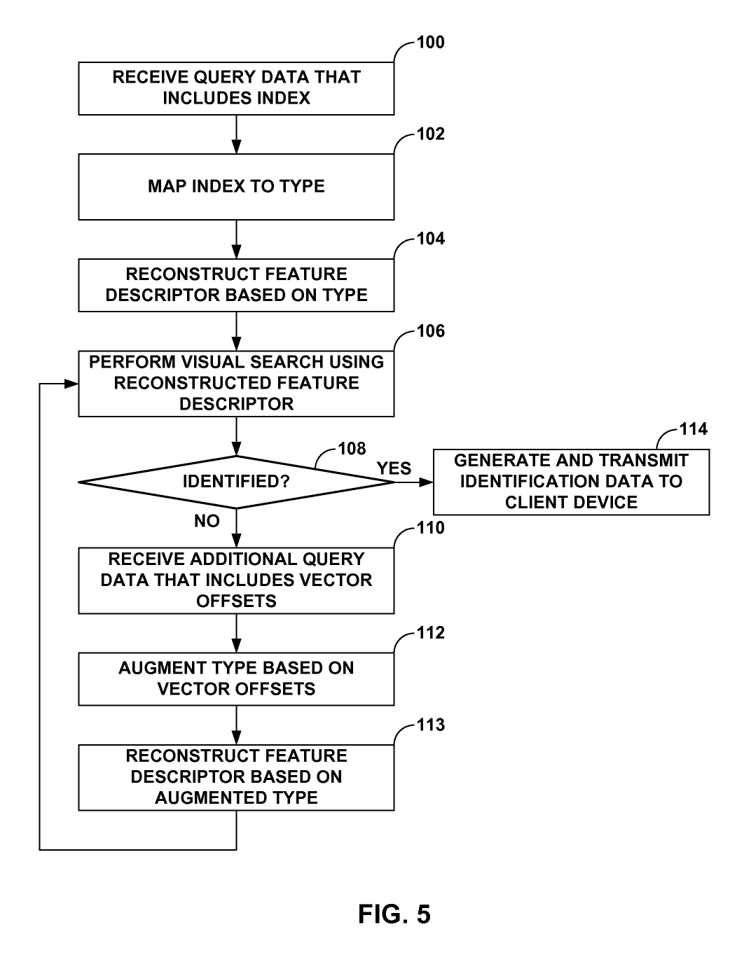

FIG. 5 is a flowchart illustrating exemplary operation of a visual search server, such as visual search server 14 shown in the example of FIG. 1, in implementing the successively refinable quantization techniques described in this disclosure. While described with respect to a particular device, i.e., visual search server 14, the techniques may be implemented by any device capable of performing mathematical operations with respect to a probability distribution so as to reduce latency in further uses of this probability distribution, such as for performing a visual search. In addition, while described in the context of a visual search, the techniques may be implemented in other contexts to facilitate the successive refinement of a probability distribution.

Initially, visual search server 14 receives query data 30A that includes an index, as described above (100). In response to receiving query data 30A, visual search server 14 invokes feature reconstruction unit 34. Referring to FIG. 3, feature reconstruction unit 34 invokes type mapping unit 60 to map the index of query data 30A to type 56 in the manner described above (102). Type mapping unit 60 outputs the determined type 56 to feature recovery unit 62. Feature recover unit 62 then reconstructs feature descriptors 28 based on type 56, outputting reconstructed feature descriptors 40A, as described above (104). Visual search server 14 then invokes feature matching unit 36, which performs a visual search using reconstructed feature descriptors 40A in the manner described above (106).

If the visual search performed by feature matching unit 36 does not result in a positive identification of the feature (“NO” 108), feature matching unit 62 does not generate and then send any identification data to client device 12. As a result of not receiving this identification data, client device 12 generates and sends offset vectors in the form of query data 30B. Visual search server 14 receives this additional query data 30B that includes these offset vectors (110). Visual search server 14 invokes feature reconstruction unit 34 to process received query data 30B. Feature reconstruction unit 34, once invoked, in turn invokes feature augmentation unit 64. Feature augmentation unit 64 augments type 54 based on the offset vectors to reconstruct feature descriptors 28 at a finer level of granularity (112).

Feature augmentation unit 64 outputs augmented or updated type 58 to feature recovery unit 62. Feature recovery unit 62 then recovers feature descriptors 28 based on updated type 58 to output reconstructed feature descriptors 40B, where reconstructed feature descriptors 40B represents feature descriptors 28 quantized at a finer level than that represented by feature descriptors 40A (113). Feature recovery unit 62 then outputs reconstructed feature descriptors 40B to feature matching unit 36. Feature matching unit 36 then reinitiates the visual search using feature descriptors 40B (106). This process may continue until the feature is identified (106-113) or until client device 12 no longer provides additional offset vectors. If identified (“YES” 108), feature matching unit 36 generates and transmits identification data 42 to the visual search client, i.e., client device 12 in this example (114).

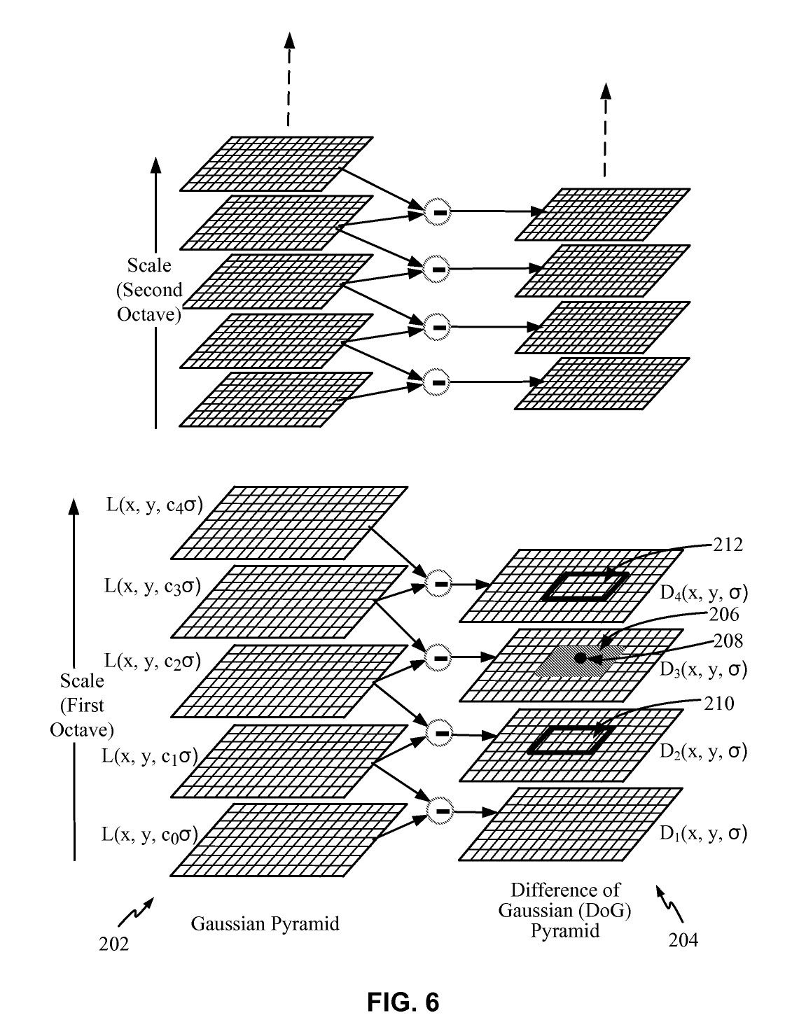

FIG. 6 is a diagram illustrating a difference of Gaussian (DoG) pyramid 204 that has been determined for use in feature descriptor extraction. Feature extraction unit 18 of FIG. 1 may construct DoG pyramid 204 by computing the difference of any two consecutive Gaussian-blurred images in Gaussian pyramid 202. The input image I(x, y), which is shown as image data 26 in the example of FIG. 1, is gradually Gaussian blurred to construct Gaussian pyramid 202. Gaussian blurring generally involves convolving the original image I(x, y) with the Gaussian blur function G(x, y, cσ) at scale cσ such that the Gaussian blurred function L(x, y, cσ) is defined as L(x, y, cσ)=G(x, y, cσ)*I(x, y). Here, G is a Gaussian kernel, cσ denotes the standard deviation of the Gaussian function that is used for blurring the image I(x, y). As c, is varied (c₀<c₁<c₂<c₃<c₄), the standard deviation cσ varies and a gradual blurring is obtained. Sigma σ is the base scale variable (essentially the width of the Gaussian kernel). When the initial image I(x, y) is incrementally convolved with Gaussians G to produce the blurred images L, the blurred images L are separated by the constant factor c in the scale space.

In DoG space or pyramid 204, D(x, y, a)=L(x, y, cₙσ)−L(x, y, cₙ₋₁σ). A DoG image D(x, y, σ) is the difference between two adjacent Gaussian blurred images L at scales cₙσ and cₙ₋₁σ. The scale of the D(x, y, σ) lies somewhere between cₙσ and cₙ₋₁σ. As the number of Gaussian-blurred images L increase and the approximation provided for Gaussian pyramid 202 approaches a continuous space, the two scales also approach into one scale. The convolved images L may be grouped by octave, where an octave corresponds to a doubling of the value of the standard deviation σ. Moreover, the values of the multipliers k (e.g., c₀<c₁<c₂<c₃<c₄), are selected such that a fixed number of convolved images L are obtained per octave. Then, the DoG images D may be obtained from adjacent Gaussian-blurred images L per octave. After each octave, the Gaussian image is down-sampled by a factor of 2 and then the process is repeated.

Feature extraction unit 18 may then use DoG pyramid 204 to identify keypoints for the image I(x, y). In performing keypoint detection, feature extraction unit 19 determines whether the local region or patch around a particular sample point or pixel in the image is a potentially interesting patch (geometrically speaking). Generally, feature extraction unit 18 identifies local maxima and/or local minima in the DoG space 204 and uses the locations of these maxima and minima as keypoint locations in DoG space 204. In the example illustrated in FIG. 6, feature extraction unit 18 identifies a keypoint 208 within a patch 206. Finding the local maxima and minima (also known as local extrema detection) may be achieved by comparing each pixel (e.g., the pixel for keypoint 208) in DoG space 204 to its eight neighboring pixels at the same scale and to the nine neighboring pixels (in adjacent patches 210 and 212) in each of the neighboring scales on the two sides, for a total of 26 pixels (9×2+8=26). If the pixel value for the keypoint 206 is a maximum or a minimum among all 26 compared pixels in the patches 206, 210, and 208, then feature extraction unit 18 selects this as a keypoint. Feature extraction unit 18 may further process the keypoints such that their location is identified more accurately. Feature extraction unit 18 may, in some instances, discard some of the keypoints, such as the low contrast key points and edge key points.

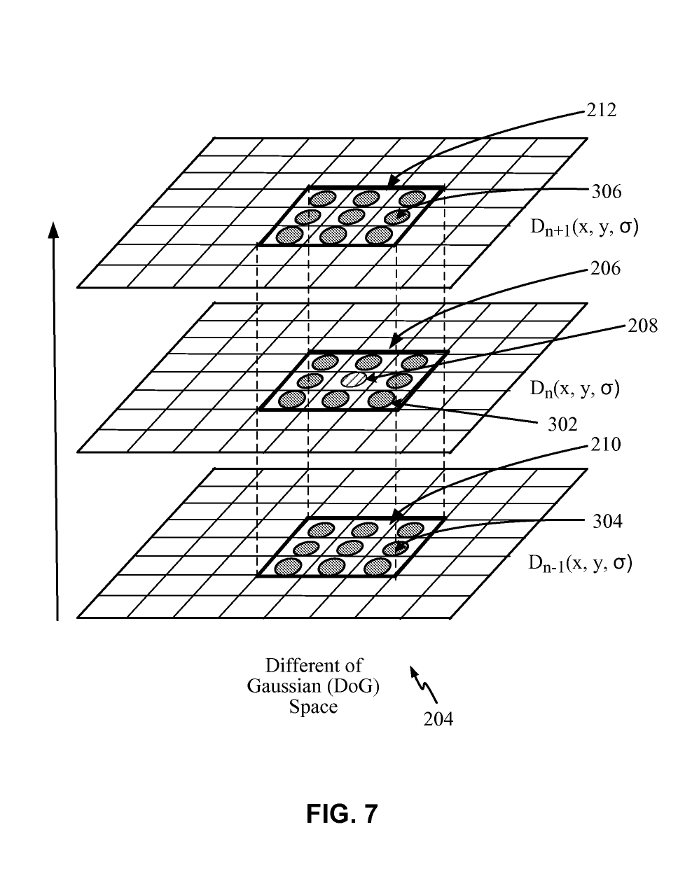

FIG. 7 is a diagram illustrating detection of a keypoint in more detail. In the example of FIG. 7, each of the patches 206, 210, and 212 include a 3×3 pixel region. Feature extraction unit 18 first compares a pixel of interest (e.g., keypoint 208) to its eight neighboring pixels 302 at the same scale (e.g., patch 206) and to the nine neighboring pixels 304 and 306 in adjacent patches 210 and 212 in each of the neighboring scales on the two sides of the keypoint 208.

Feature extraction unit 18 may assign each keypoint one or more orientations, or directions, based on the directions of the local image gradient. By assigning a consistent orientation to each keypoint based on local image properties, feature extraction unit 18 may represent the keypoint descriptor relative to this orientation and therefore achieve invariance to image rotation. Feature extraction unit 18 then calculates magnitude and direction for every pixel in the neighboring region around the keypoint 208 in the Gaussian-blurred image L and/or at the keypoint scale. The magnitude of the gradient for the keypoint 208 located at (x, y) may be represented as m(x, y) and the orientation or direction of the gradient for the keypoint at (x, y) may be represented as Γ(x, y).

Feature extraction unit 18 then uses the scale of the keypoint to select the Gaussian smoothed image, L, with the closest scale to the scale of the keypoint 208, so that all computations are performed in a scale-invariant manner. For each image sample, L(x, y), at this scale, feature extraction unit 18 computes the gradient magnitude, m(x, y), and orientation, Γ(x, y), using pixel differences. For example the magnitude m(x,y) may be computed in accordance with the following equation (28):

$$m ( x , y ) = \sqrt{{( L ( x + 1 , y ) - L ( x - 1 , y ) )}^{2} + {( L ( x , y + 1 ) - L ( x , y - 1 ) )}^{2}} . \qquad ( 28 )$$

Feature extraction unit 18 may calculate the direction or orientation Γ(x, y) in accordance with the following equation (29):

$$Γ ( x , y ) = arctan [ \frac{( L ( x , y + 1 ) L ( x , y - 1 )}{( L ( x + 1 , y ) - L ( x - 1 , y )} ] . \qquad ( 29 )$$

In equation (29), L(x, y) represents a sample of the Gaussian-blurred image L(x, y, σ), at scale σ which is also the scale of the keypoint.

Feature extraction unit 18 may consistently calculate the gradients for the keypoint either for the plane in the Gaussian pyramid that lies above, at a higher scale, than the plane of the keypoint in the DoG space or in a plane of the Gaussian pyramid that lies below, at a lower scale, than the keypoint. Either way, for each keypoint, feature extraction unit 18 calculates the gradients at the same scale in a rectangular area (e.g., patch) surrounding the keypoint. Moreover, the frequency of an image signal is reflected in the scale of the Gaussian-blurred image. Yet, SIFT and other algorithm, such as a compressed histogram of gradients (CHoG) algorithm, simply use gradient values at all pixels in the patch (e.g., rectangular area). A patch is defined around the keypoint; sub-blocks are defined within the block; samples are defined within the sub-blocks and this structure remains the same for all keypoints even when the scales of the keypoints are different. Therefore, while the frequency of an image signal changes with successive application of Gaussian smoothing filters in the same octave, the keypoints identified at different scales may be sampled with the same number of samples irrespective of the change in the frequency of the image signal, which is represented by the scale.

To characterize a keypoint orientation, feature extraction unit 18 may generate a gradient orientation histogram (see FIG. 4) by using, for example, Compressed Histogram of Gradients (CHoG). The contribution of each neighboring pixel may be weighted by the gradient magnitude and a Gaussian window. Peaks in the histogram correspond to dominant orientations. Feature extraction unit 18 may measure all the properties of the keypoint relative to the keypoint orientation, this provides invariance to rotation.

In one example, feature extraction unit 18 computes the distribution of the Gaussian-weighted gradients for each block, where each block is 2 sub-blocks by 2 sub-blocks for a total of 4 sub-blocks. To compute the distribution of the Gaussian-weighted gradients, feature extraction unit 18 forms an orientation histogram with several bins with each bin covering a part of the area around the keypoint. For example, the orientation histogram may have 36 bins, each bin covering 10 degrees of the 360 degree range of orientations. Alternatively, the histogram may have 8 bins, each covering 45 degrees of the 360 degree range. It should be clear that the histogram coding techniques described herein may be applicable to histograms of any number of bins.

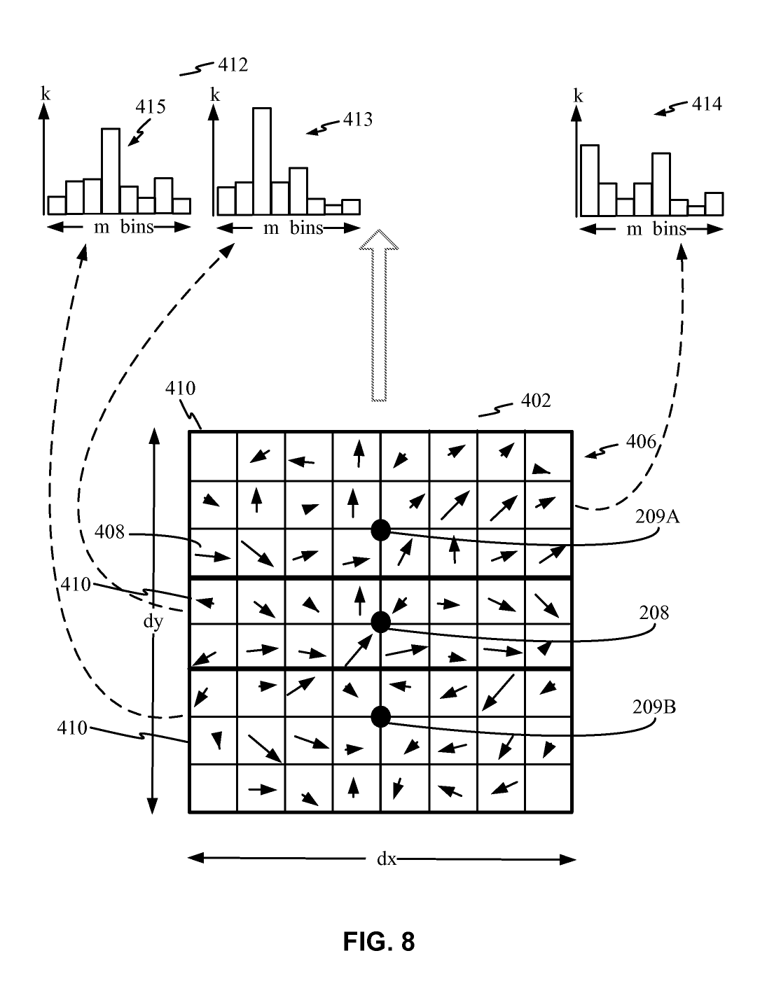

FIG. 8 is a diagram illustrating the process by which a feature extraction unit, such as feature extraction unit 18, determines a gradient distribution and an orientation histogram. Here, a two-dimensional gradient distribution (dx, dy) (e.g., block 406) is converted to a one-dimensional distribution (e.g., histogram 414). The keypoint 208 is located at a center of the patch 406 (also called a cell or region) that surrounds the keypoint 208. The gradients that are pre-computed for each level of the pyramid are shown as small arrows at each sample location 408. As shown, regions of samples 408 form sub-blocks 410, which may also be referred to as bins 410. Feature extraction unit 18 may employ a Gaussian weighting function to assign a weight to each sample 408 within sub-blocks or bins 410. The weight assigned to each of the sample 408 by the Gaussian weighting function falls off smoothly from centroids 209A, 209B and keypoint 208 (which is also centroid) of bins 410. The purpose of the Gaussian weighting function is to avoid sudden changes in the descriptor with small changes in position of the window and to give less emphasis to gradients that are far from the center of the descriptor. Feature extraction unit 18 determines an array of orientation histograms 412 with 8 orientations in each bin of the histogram resulting in a dimensional feature descriptor. For example, orientation histograms 413 may correspond to the gradient distribution for sub-block 410.

In some instances, feature extraction unit 18 may use other types of quantization bin constellations (e.g., with different Voronoi cell structures) to obtain gradient distributions. These other types of bin constellations may likewise employ a form of soft binning, where soft binning refers to overlapping bins, such as those defined when a so-called DAISY configuration is employed. In the example of FIG. 8, the three soft bins are defined, however, as many as 9 or more may be used with centroids generally positioned in a circular configuration around keypoint 208. That is, bin centers or centroids 208, 209A, 209B,

As used herein, a histogram is a mapping ki that counts the number of observations, sample, or occurrences (e.g., gradients) that fall into various disjoint categories known as bins. The graph of a histogram is merely one way to represent a histogram. Thus, if k is the total number of observations, samples, or occurrences and m is the total number of bins, the frequencies in histogram ki satisfy the following condition expressed as equation (30):

$$n = {\sum }_{i = 1}^{m} {k}_{i} , \qquad ( 30 )$$

where Σ is the summation operator.

Feature extraction unit 18 may weight each sample added to the histograms 412 by its gradient magnitude defined by the Gaussian-weighted function with a standard deviation that is 1.5 times the scale of the keypoint. Peaks in the resulting orientation histogram 414 correspond to dominant directions of local gradients. Feature extraction unit 18 then detects the highest peak in the histogram and then any other local peak that is within a certain percentage, such as 80%, of the highest peak (which it may also use to also create a keypoint with that orientation). Therefore, for locations with multiple peaks of similar magnitude, feature extraction unit 18 extracts multiple keypoints created at the same location and scale but different orientations.

Feature extraction unit 18 then quantizes the histograms using a form of quantization referred to as type quantization, which expresses the histogram as a type. In this manner, feature extraction unit 18 may extract a descriptor for each keypoint, where such descriptor may be characterized by a location (x, y), an orientation, and a descriptor of the distributions of the Gaussian-weighted gradients in the form of a type. In this way, an image may be characterized by one or more keypoint descriptors (also referred to as image descriptors).

FIGS. 9A, 9B are graphs 500A, 500B depicting feature descriptors 502A, 502B, respectively and reconstruction points 504-508 determined in accordance with the techniques described in this disclosure. The axis in FIGS. 9A and 9B (denoted as “p1,” “p2” and “p3” refer to parameters of the feature descriptor space, which define probabilities of the cells of the histograms discussed above. Referring first to the example of FIG. 9A, feature descriptor 502A has been divided into Voronoi cells 512A-512F. At the center of each Voronoi cell, feature compression unit 20 determines reconstruction points 504 when base quantization level 54 (shown in the example of FIG. 2) equals two. Feature compression unit 20 then, in accordance with the techniques described in this disclosure, determines additional reconstruction points 506 (denoted by white/black dots in the example of FIG. 9A) that augment reconstruction points 504 in accordance with the first above-described way of determining these additional reconstruction points such that when reconstruction points 504 are updated with additional reconstruction points 506, the resulting feature descriptor 500A is reconstructed at a higher quantization level (i.e., n=4 in this example). In this first way, additional reconstruction points 506 are determined to lie at the center of each face of Voronoi cells 512.

Referring next to the example of FIG. 9B, feature descriptor 502B has been divided into Voronoi cells 512A-512F. At the center of each Voronoi cell, feature compression unit 20 determines reconstruction points 504 when base quantization level 54 (shown in the example of FIG. 2) equals two. Feature compression unit 20 then, in accordance with the techniques described in this disclosure, determines additional reconstruction points 508 (denoted by white/black dots in the example of FIG. 9B) that augment reconstruction points 504 in accordance with the second above-described way of determining these additional reconstruction points such that when reconstruction points 504 are updated with additional reconstruction points 508, the resulting feature descriptor 500A is reconstructed at a higher quantization level (i.e., n=4 in this example). In this second way, additional reconstruction points 508 are determined to lie at the vertices of each of Voronoi cells 512.

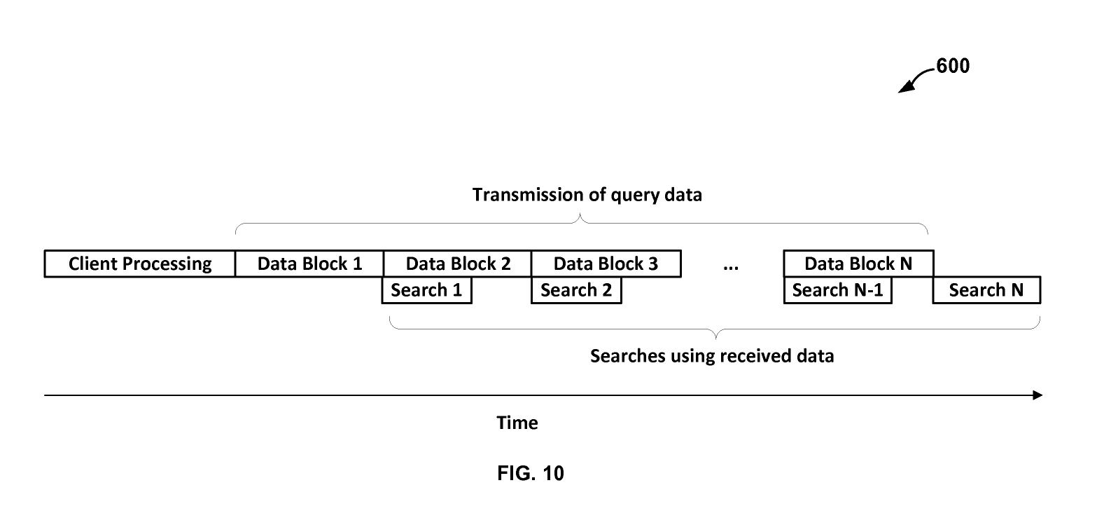

FIG. 10 is a time diagram 600 illustrating latency with respect to a system, such as system 10 shown in the example of FIG. 1, that implements the techniques described in this disclosure. The line at the bottom denotes the passing of time from the initiation of the search by the user (denoted by zero) to the positive identification of the feature descriptor (which in this example occurs by a sixth unit of time). Client device 12 initially introduces one unit of latency in extracting the feature descriptor, quantizing the feature descriptor at the base level and sending the feature descriptor. Client device 12, however, introduces no further latency in this example because it computes the successive offset vectors to further refine the feature descriptor in accordance with the techniques of this disclosure while network 16 relays query data 30A and visual search server 14 performs the visual search with respect to query data 30A. Thereafter, only network 16 and visual search server 14 contribute to latency, although such contributions overlap in that while network 16 delivers the offset vector, server 14 performs the visual search with respect to query data 30A. Thereafter, each update results in concurrent execution of network 16 and server 14 such that latency may be greatly reduced in comparison to conventional system, especially considering the concurrent execution of client device 12 and server 14.

In one or more examples, the functions described may be implemented in hardware, software, firmware, or any combination thereof. If implemented in software, the functions may be stored on or transmitted over as one or more instructions or code on a computer-readable medium. Computer-readable media may include computer data storage media or communication media including any medium that facilitates transfer of a computer program from one place to another. Data storage media may be any available media that can be accessed by one or more computers or one or more processors to retrieve instructions, code and/or data structures for implementation of the techniques described in this disclosure. By way of example, and not limitation, such computer-readable media can comprise RAM, ROM, EEPROM, CD-ROM or other optical disk storage, magnetic disk storage, or other magnetic storage devices, flash memory, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

The code may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware stored to either transitory or non-transitory computer-readable mediums.

Various examples have been described. These and other examples are within the scope of the following claims.

1. A method for performing a visual search in a network system in which a client device transmits query data via a network to a visual search device, the method comprising:
extracting, with the client device, a set of image feature descriptors from a query image, wherein the image feature descriptors define at least one feature of the query image;
quantizing, with the client device, the set of image feature descriptors at a first quantization level to generate first query data representative of the set of image feature descriptors quantized at the first quantization level;
transmitting, with the client device, the first query data to the visual search device via the network;
determining, with the client device, second query data that augments the first query data such that, when the first query data is updated with the second query data, the updated first query data is representative of the set of image feature descriptor quantized at a second quantization level, wherein the second quantization level achieves a more accurate representation of the set of image feature descriptors than that achieved when quantizing at the first quantization level; and
transmitting, with the client device, the second query data to the visual search device via the network to refine the first query data.

2. The method of claim 1, wherein transmitting the second query data comprises transmitting the second query data concurrently with the visual search device performing the visual search using the first query data representative of the image feature descriptors quantized at the first quantization level.

3. The method of claim 1,
wherein quantizing the image feature descriptors at a first quantization level includes determining reconstruction points such that the reconstruction points are each located at a center of different ones of Voronoi cells defined for the image feature descriptors, where the Voronoi cells include faces defining the boundaries between the Voronoi cells and vertices where two or more of the faces intersect,
wherein determining second query data includes:
determining additional reconstruction points such that the additional reconstruction points are each located at a center of each of the faces;
specifying the additional reconstruction points as offset vectors from each of the previously determined reconstruction points; and
generating the second query data to include the offset vectors.

4. The method of claim 1,
wherein quantizing the image feature descriptors at a first quantization level includes determining reconstruction points such that the reconstruction points are each located at a center of different ones of Voronoi cells defined for the image feature descriptors, where the Voronoi cells include faces defining the boundaries between the Voronoi cells and vertices where two or more of the faces intersect,
wherein determining second query data includes:
determining additional reconstruction points such that the additional reconstruction points are each located at the vertices of the Voronoi cells;
specifying the additional reconstruction points as offset vectors from each of the previously determined reconstruction points;
generating the second query data to include the offset vectors.

5. The method of claim 1,
wherein each of the image feature descriptors comprises histograms of gradients sampled around a feature location in the image,
wherein quantizing the image feature descriptors at a first quantization level includes:
determining a nearest type for the histogram of gradients, wherein the type is a set of rational numbers with a given common denominator and wherein a sum of the set of rational numbers equals one; and
mapping the determined type to an index that uniquely identifies a lexicographic arrangement of the determined type with respect to all possible types having the given common denominator, and
wherein the first query data includes the type index.

6. The method of claim 1, further comprising:
prior to transmitting the second query data, receiving identification data from the visual search device obtained as a result of searching in a database maintained by the visual search device;
terminating the visual search without sending the second query data; and
using the identification data in a visual search application.

7. The method of claim 1, further comprising:
determining third query data that further augments the first and second query data such that when the first query data after being augmented by the second query data is updated with the third query data the successively updated first query data is representative of the image feature descriptors quantized at a third quantization level, wherein the third quantization level achieves an even more accurate representation of the image feature descriptor data than that achieved when quantizing at the second quantization level; and
transmitting the third query data to the visual search device via the network to successively refine the first query data after being augmented by the second query data.

8. A method for performing a visual search in a network system in which a client device transmits query data via a network to a visual search device, the method comprising:
performing, with the visual search device, the visual search using first query data, wherein the first query data is representative of a set of image feature descriptors extracted from an image and compressed through quantization at a first quantization level;
receiving, with the visual search device, second query data from the client device via the network, wherein the second query data augments the first data such that when the first query data is updated with the second query data the updated first query data is representative of the set of image feature descriptors quantized at a second quantization level, wherein the second quantization level achieves a more accurate representation of the image feature descriptors than that achieved when quantizing at the first quantization level;
updating, with the visual search device, the first query data with the second query data to generate updated first query data that is representative of the image feature descriptors quantized at the second quantization level; and
performing, with the visual search device, the visual search using the updated first query data.

9. The method of claim 8, wherein performing the visual search using the first query data comprises performing the visual search using the first query data concurrently with transmittal of the second query data from the client device to the visual search device via the network.

10. The method of claim 8,
wherein the first query data defines reconstruction points such that the reconstruction points are each located at a center of different ones of Voronoi cells defined for the image feature descriptors, where the Voronoi cells include faces defining the boundaries between the Voronoi cells and vertices where two or more of the faces intersect,
wherein the second query data includes offset vectors that specify locations of additional reconstruction points relative to each of the previously defined reconstruction points, wherein the additional reconstruction points are each located at a center of each of the faces, and
wherein updating the first query data with the second query data to generate the updated first query data includes adding the additional reconstruction points to the previously defined reconstruction points based on the offset vectors.

11. The method of claim 8,
wherein the first query data defines reconstruction points such that the reconstruction points are each located at a center of different ones of Voronoi cells defined for the image feature descriptor, where the Voronoi cells include faces defining the boundaries between the Voronoi cells and vertices where two or more of the faces intersect,
wherein the second query data includes offset vectors that specify locations of additional reconstruction points relative to each of the previously defined reconstruction points, wherein the additional reconstruction points are each located at the vertices of the Voronoi cells, and
wherein updating the first query data with the second query data to generate the updated first query data includes adding the additional reconstruction points to the previously defined reconstruction points based on the offset vectors.

12. The method of claim 8,
wherein each of the image feature descriptors comprises histograms of gradients sampled around a feature location in the image,
wherein the first query data includes a type index, wherein the type index uniquely identifies a type in a lexicographical arrangement of types having a given common denominator, wherein each of the types comprise a set of rational numbers with the given common denominator, and wherein the set of rational numbers of each type sums to one,
wherein the method further comprises:
mapping the type index to the type; and
reconstructing the histograms of gradients from the type, and
wherein performing the visual search using the first query data includes performing the visual search using the reconstructed histograms of gradients.

13. The method of claim 12, wherein updating the first query data comprises:
updating the type with the second query data to generate an updated type; and
reconstructing the image feature descriptors at the second quantization level based on the updated type.

14. The method of claim 8, further comprising:
prior to receiving the second query data, determining identification data as a result of performing the visual search in a database maintained by the visual search device using the first query data; and
transmitting the identification data prior to receiving the second query data to effectively terminate the visual search.

15. The method of claim 8, further comprising:
receiving third query data that further augments the first and second query data such that when the first query data after being augmented by the second query data is updated with the third query data the successively updated first query data is representative of the image feature descriptors quantized at a third quantization level, wherein the third quantization level achieves a more accurate representation of the image feature descriptor data than that achieved when quantizing at the second quantization level;
updating the updated first query data with the third query data to generate twice updated first query data that is representative of the image feature descriptors quantized at the third quantization level; and
performing the visual search using the twice updated first query data.

16. A client device that transmits query data via a network to a visual search device so as to perform a visual search, the client device comprising:
a memory that stores data defining an image;
a feature extraction unit that extracts a set of image feature descriptors from the image, wherein the image feature descriptors defines at least one feature of the image;
a feature compression unit that quantizes the image feature descriptors at a first quantization level to generate first query data representative of the image feature descriptors quantized at the first quantization level; and
an interface that transmits the first query data to the visual search device via the network,
wherein the feature compression unit determines second query data that augments the first query data such that when the first query data is updated with the second query data the updated first query data is representative of the image feature descriptors quantized at a second quantization level, wherein the second quantization level achieves a more accurate representation of the image feature descriptors than that achieved when quantizing at the first quantization level, and
wherein the interface transmits the second query data to the visual search device via the network to successively refine the first query data.

17. The client device of claim 16, wherein the interface transmits the second query data concurrent to the visual search device performing the visual search using the first query data representative of the image feature descriptor quantized at the first quantization level.

18. The client device of claim 16,
wherein the feature compression unit determines reconstruction points such that the reconstruction points are each located at a center of different ones of Voronoi cells defined for the image feature descriptors, where the Voronoi cells include faces defining the boundaries between the Voronoi cells and vertices where two or more of the faces intersect, and
wherein the feature compression unit determines additional reconstruction points such that the additional reconstruction points are each located at a center of each of the faces, specifies the additional reconstruction points as offset vectors from each of the previously determined reconstruction points and generates the second query data to include the offset vectors.

19. The client device of claim 16,
wherein the feature compression unit determines reconstruction points such that the reconstruction points are each located at a center of different ones of Voronoi cells defined for the image feature descriptors, where the Voronoi cells include faces defining the boundaries between the Voronoi cells and vertices where two or more of the faces intersect, and
wherein the feature compression unit further determines additional reconstruction points such that the additional reconstruction points are each located at the vertices of the Voronoi cells, specifies the additional reconstruction points as offset vectors from each of the previously determined reconstruction points and generates the second query data to include the offset vectors.

20. The client device of claim 16,
wherein each of the image feature descriptors comprises histograms of gradients sampled around a feature location in the image,
wherein the feature compression unit further determines a nearest type for the histogram of gradients, wherein the type is a set of rational numbers with a given common denominator and wherein a sum of the set of rational numbers equals one and maps the determined type to a type index that uniquely identifies a lexicographic arrangement of the determined type with respect to all possible types having the given common denominator, and
wherein the first query data includes the type index.

21. The client device of claim 16,
wherein the interface, prior to transmitting the second query data, receives identification data from the visual search device obtained as a result of searching in a database maintained by the visual search device,
wherein the client device terminates the visual search without sending the second query data in response to receiving the identification data, and
wherein the client device includes a processor that executes a visual search application that uses the identification data.

22. The client device of claim 16,
wherein the feature compression unit determines third query data that further augments the first and second query data such that when the first query data after being augmented by the second query data is updated with the third query data the successively updated first query data is representative of the image feature descriptors quantized at a third quantization level, wherein the third quantization level achieves an even more accurate representation of the image feature descriptor data than that achieved when quantizing at the second quantization level, and
wherein the interface transmits the third query data to the visual search device via the network to successively refine the first query data after being augmented by the second query data.

23. A visual search device for performing a visual search in a network system in which a client device transmits query data via a network to the visual search device, the visual search device comprising:
an interface that receives first query data from the client device via the network,
wherein the first query data is representative of a set of image feature descriptors extracted from an image and compressed through quantization at a first quantization level; and
a feature matching unit that performs the visual search using the first query data,
wherein the interface further receives second query data from the client device via the network, wherein the second query data augments the first data such that when the first query data is updated with the second query data the updated first query data is representative of the image feature descriptors quantized at a second quantization level,
wherein the second quantization level achieves a more accurate representation of the image feature descriptors than that achieved when quantizing at the first quantization level; and
a feature reconstruction unit that updates the first query data with the second query data to generate updated first query data that is representative of the image feature descriptors quantized at a second quantization level,
wherein the feature matching unit performs the visual search using the updated first query data.

24. The visual search device of claim 23, wherein the feature matching unit performs the visual search using the first query data concurrent to transmittal of the second query data from the client device to the visual search device via the network.

25. The visual search device of claim 23,
wherein the first query data defines reconstruction points such that the reconstruction points are each located at a center of different ones of Voronoi cells defined for the image feature descriptors, where the Voronoi cells include faces defining the boundaries between the Voronoi cells and vertices where two or more of the faces intersect,
wherein the second query data includes offset vectors that specify locations of additional reconstruction points relative to each of the previously defined reconstruction points, wherein the additional reconstruction points are each located at a center of each of the faces, and
wherein the feature reconstruction unit adds the additional reconstruction points to the previously defined reconstruction points based on the offset vectors.

26. The visual search device of claim 23,
wherein the first query data defines reconstruction points such that the reconstruction points are each located at a center of different ones of Voronoi cells defined for the image feature descriptor, where the Voronoi cells include faces defining the boundaries between the Voronoi cells and vertices where two or more of the faces intersect,
wherein the second query data includes offset vectors that specify locations of additional reconstruction points relative to each of the previously defined reconstruction points, wherein the additional reconstruction points are each located at the vertices of the Voronoi cells, and
wherein the feature reconstruction unit adds the additional reconstruction points to the previously defined reconstruction points based on the offset vectors.

27. The visual search device of claim 23,
wherein each of the image feature descriptors comprises histograms of gradients sampled around a feature location in the image,
wherein the first query data includes a type index, wherein the type index uniquely identifies a type in a lexicographical arrangement of types having a given common denominator, wherein each of the types comprise a set of rational numbers with the given common denominator, and wherein the set of rational numbers of each type sums to one,
wherein the feature reconstruction unit maps the type index to the type and reconstructs the histograms of gradients from the type, and
wherein the feature matching unit performs the visual search using the reconstructed histograms of gradients.

28. The visual search device of claim 27, wherein the feature reconstruction unit further updates the type with the second query data to generate an updated type and reconstructs the image feature descriptors at the second quantization level based on the updated type.

29. The visual search device of claim 23,
wherein the feature matching unit, prior to receiving the second query data, determines identification data as a result of performing the visual search in a database maintained by the visual search device using the first query data, and
wherein the interface transmits the identification data prior to receiving the second query data to effectively terminate the visual search.

30. The visual search device of claim 23,
wherein the interface receives third query data that further augments the first and second query data such that when the first query data after being augmented by the second query data is updated with the third query data the successively updated first query data is representative of the image feature descriptors quantized at a third quantization level, wherein the third quantization level achieves a more accurate representation of the image feature descriptor data than that achieved when quantizing at the second quantization level,
wherein the feature reconstruction unit updates the updated first query data with the third query data to generate twice updated first query data that is representative of the image feature descriptors quantized at the third quantization level and
wherein the feature matching unit performs the visual search using the twice updated first query data.

31. A device that transmits query data via a network to a visual search device, the device comprising:
means for storing data defining a query image;
means for extracting a set of image feature descriptors from the query image, wherein the image feature descriptors define at least one feature of the query image;
means for quantizing the set of image feature descriptors at a first quantization level to generate first query data representative of the set of image feature descriptors quantized at the first quantization level;
means for transmitting the first query data to the visual search device via the network;
means for determining second query data that augments the first query data such that, when the first query data is updated with the second query data, the updated first query data is representative of the set of image feature descriptor quantized at a second quantization level, wherein the second quantization level achieves a more accurate representation of the set of image feature descriptors than that achieved when quantizing at the first quantization level; and
means for transmitting the second query data to the visual search device via the network to refine the first query data.

32. The device of claim 31, wherein the means for transmitting the second query data comprises means for transmitting the second query data concurrently with the visual search device performing the visual search using the first query data representative of the image feature descriptors quantized at the first quantization level.

33. The device of claim 31,
wherein the means for quantizing the image feature descriptors at a first quantization level includes means for determining reconstruction points such that the reconstruction points are each located at a center of different ones of Voronoi cells defined for the image feature descriptors, where the Voronoi cells include faces defining the boundaries between the Voronoi cells and vertices where two or more of the faces intersect,
wherein the means for determining second query data includes:
means for determining additional reconstruction points such that the additional reconstruction points are each located at a center of each of the faces;
means for specifying the additional reconstruction points as offset vectors from each of the previously determined reconstruction points; and
means for generating the second query data to include the offset vectors.

34. The device of claim 31,
wherein the means for quantizing the image feature descriptors at a first quantization level includes means for determining reconstruction points such that the reconstruction points are each located at a center of different ones of Voronoi cells defined for the image feature descriptors, where the Voronoi cells include faces defining the boundaries between the Voronoi cells and vertices where two or more of the faces intersect,
wherein the means for determining second query data includes:
means for determining additional reconstruction points such that the additional reconstruction points are each located at the vertices of the Voronoi cells;
means for specifying the additional reconstruction points as offset vectors from each of the previously determined reconstruction points;
means for generating the second query data to include the offset vectors.

35. The device of claim 31,
wherein each of the image feature descriptors comprises histograms of gradients sampled around a feature location in the image,
wherein the means for quantizing the image feature descriptors at a first quantization level includes:
means for determining a nearest type for the histogram of gradients, wherein the type is a set of rational numbers with a given common denominator and wherein a sum of the set of rational numbers equals one; and
means for mapping the determined type to a type index that uniquely identifies a lexicographic arrangement of the determined type with respect to all possible types having the given common denominator, and
wherein the first query data includes the type index.

36. The device of claim 31, further comprising:
means for receiving, prior to transmitting the second query data, identification data from the visual search device obtained as a result of searching in a database maintained by the visual search device;
means for terminating the visual search without sending the second query data; and
means for using the identification data in a visual search application.

37. The device of claim 31, further comprising:
means for determining third query data that further augments the first and second query data such that when the first query data after being augmented by the second query data is updated with the third query data the successively updated first query data is representative of the image feature descriptors quantized at a third quantization level, wherein the third quantization level achieves an even more accurate representation of the image feature descriptor data than that achieved when quantizing at the second quantization level; and
means for transmitting the third query data to the visual search device via the network to successively refine the first query data after being augmented by the second query data.

38. A device for performing a visual search in a network system in which a client device transmits query data via a network to a visual search device, the device comprising:
means for receiving first query data from the client device via the network, wherein the first query data is representative of a set of image feature descriptors extracted from an image and compressed through quantization at a first quantization level;
means for performing the visual search using the first query data;
means for receiving second query data from the client device via the network, wherein the second query data augments the first data such that when the first query data is updated with the second query data the updated first query data is representative of the set of image feature descriptors quantized at a second quantization level, wherein the second quantization level achieves a more accurate representation of the image feature descriptors than that achieved when quantizing at the first quantization level;
means for updating the first query data with the second query data to generate updated first query data that is representative of the image feature descriptors quantized at the second quantization level; and
means for performing the visual search using the updated first query data.

39. The device of claim 38, wherein the means for performing the visual search using the first query data comprises means for performing the visual search using the first query data concurrently with transmittal of the second query data from the client device to the visual search device via the network.

40. The device of claim 38,
wherein the first query data defines reconstruction points such that the reconstruction points are each located at a center of different ones of Voronoi cells defined for the image feature descriptors, where the Voronoi cells include faces defining the boundaries between the Voronoi cells and vertices where two or more of the faces intersect,
wherein the second query data includes offset vectors that specify locations of additional reconstruction points relative to each of the previously defined reconstruction points, wherein the additional reconstruction points are each located at a center of each of the faces, and
wherein the means for updating the first query data with the second query data to generate the updated first query data includes means for adding the additional reconstruction points to the previously defined reconstruction points based on the offset vectors.

41. The device of claim 38,
wherein the first query data defines reconstruction points such that the reconstruction points are each located at a center of different ones of Voronoi cells defined for the image feature descriptor, where the Voronoi cells include faces defining the boundaries between the Voronoi cells and vertices where two or more of the faces intersect,
wherein the second query data includes offset vectors that specify locations of additional reconstruction points relative to each of the previously defined reconstruction points, wherein the additional reconstruction points are each located at the vertices of the Voronoi cells, and
wherein the means for updating the first query data with the second query data to generate the updated first query data includes means for adding the additional reconstruction points to the previously defined reconstruction points based on the offset vectors.

42. The device of claim 38,
wherein each of the image feature descriptors comprises histograms of gradients sampled around a feature location in the image,
wherein the first query data includes a type index, wherein the type index uniquely identifies a type in a lexicographical arrangement of types having a given common denominator, wherein each of the types comprise a set of rational numbers with the given common denominator, and wherein the set of rational numbers of each type sums to one,
wherein the device further comprises:
means for mapping the type index to the type; and
means for reconstructing the histograms of gradients from the type, and
wherein the means for performing the visual search using the first query data includes means for performing the visual search using the reconstructed histograms of gradients.

43. The device of claim 42, wherein the means for updating the first query data comprises:
means for updating the type with the second query data to generate an updated type; and
means for reconstructing the image feature descriptors at the second quantization level based on the updated type.

44. The device of claim 38, further comprising:
means for determining, prior to receiving the second query data, identification data as a result of performing the visual search in a database maintained by the visual search device using the first query data; and
means for transmitting the identification data prior to receiving the second query data to effectively terminate the visual search.

45. The device of claim 38, further comprising:
means for receiving third query data that further augments the first and second query data such that when the first query data after being augmented by the second query data is updated with the third query data the successively updated first query data is representative of the image feature descriptors quantized at a third quantization level, wherein the third quantization level achieves a more accurate representation of the image feature descriptor data than that achieved when quantizing at the second quantization level;
means for updating the updated first query data with the third query data to generate twice updated first query data that is representative of the image feature descriptors quantized at the third quantization level; and
means for performing the visual search using the twice updated first query data.

46. A non-transitory computer-readable medium comprising instruction that, when executed, cause one or more processors to:
store data defining a query image;
extract an image feature descriptor from the query image, wherein the image feature descriptor defines a feature of the query image;
quantize the image feature descriptor at a first quantization level to generate first query data representative of the image feature descriptor quantized at the first quantization level;
transmit the first query data to the visual search device via the network;
determine second query data that augments the first query data such that when the first query data is updated with the second query data the updated first query data is representative of the image feature descriptor quantized at a second quantization level, wherein the second quantization level achieves a more accurate representation of the image feature descriptor data than that achieved when quantizing at the first quantization level; and
transmit the second query data to the visual search device via the network to successively refine the first query data.

47. A non-transitory computer-readable medium comprising instruction that, when executed, cause one or more processors to:
receive first query data from the client device via the network, wherein the first query data is representative of an image feature descriptor extracted from an image and compressed through quantization at a first quantization level;
perform the visual search using the first query data;
receive second query data from the client device via the network, wherein the second query data augments the first data such that when the first query data is updated with the second query data the updated first query data is representative of the image feature descriptor quantized at a second quantization level, wherein the second quantization level achieves a more accurate representation of the image feature descriptor than that achieved when quantizing at the first quantization level;
update the first query data with the second query data to generate updated first query data that is representative of the image feature descriptor quantized at a second quantization level; and
perform the visual search using the updated first query data.

48. A network system for performing a visual search, wherein the network system comprises:
a client device;
a visual search device; and
a network to which the client device and visual search device interface to communicate with one another to perform the visual search,
wherein the client device includes:
a non-transitory computer-readable medium that stores data defining an image;
a client processor that extracts an image feature descriptor from the image, wherein the image feature descriptor defines a feature of the image and quantizes the image feature descriptor at a first quantization level to generate first query data representative of the image feature descriptor quantized at the first quantization level; and
a first network interface that transmits the first query data to the visual search device via the network;
wherein the visual search device includes:
a second network interface that receives the first query data from the client device via the network; and
a server processor that performs the visual search using the first query data,
wherein the client processor determines second query data that augments the first query data such that when the first query data is updated with the second query data the updated first query data is representative of the image feature descriptor quantized at a second quantization level, wherein the second quantization level achieves a more accurate representation of the image feature descriptor than that achieved when quantizing at the first quantization level,
wherein the first network interface transmits the second query data to the visual search device via the network to successively refine the first query data,
wherein the second network interface receives the second query data from the client device via the network,
wherein the server processor updates the first query data with the second query data to generate updated first query data that is representative of the image feature descriptor quantized at a second quantization level and performs the visual search using the updated first query data.
